(19) United States
(12) Patent Application Publication
(10) Pub. No.: US 2026/0097422 A1
(43) Pub. Date: Apr. 9, 2026

(54) ELECTRODE CLEANING APPARATUS FOR ELECTRO-HYDRODYNAMIC AIR MOVER DEVICE

(71) Applicant: Ventiva, Inc., Fremont, CA (US)

(72) Inventors: Jeffrey S. Nespor, Pleasanton, CA (US); Gary Alfred Oliverio, San Jose, CA (US); Himanshu Pokharna, Saratoga, CA (US); Barry O’Connell, Palo Alto, CA (US); Brian Piorek, Fremont, CA (US); Srikanth Ganesan, Fremont, CA (US); Safi Matin, Fremont, CA (US); Collin Connors, San Jose, CA (US); Robert Haden Garrett, San Francisco, CA (US)

(21) Appl. No.: 19/349,909

(22) Filed: Oct. 3, 2025

Related U.S. Application Data
(60) Provisional application No. 63/704,506, filed on Oct. 7, 2024.
(60) Provisional application No. 63/741,715, filed on Jan. 3, 2025.
(60) Provisional application No. 63/741,706, filed on Jan. 3, 2025.

(51) Int. Cl. B08B 1/30; B08B 1/16; B08B 13/00; H01J 9/00

(52) U.S. Cl. CPC B08B 1/30; B08B 1/165; B08B 13/00; H01J 9/00; H01J 2209/017

(57) ABSTRACT

An electrode cleaning apparatus for an electro-hydrodynamic (EHD) air mover device includes a cleaning scraper formed of one or more non-conductive materials. The cleaning scraper is positioned on an elongate emitter electrode and has an opening sized and shaped to receive the emitter electrode such that the cleaning scraper is slidable longitudinally along the electrode. In one embodiment, the elongate emitter electrode is implemented as a conductive edge on a mounting isolator, and the cleaning scraper is configured to engage the conductive edge and remove deposits accumulated thereon during operation.

### CROSS REFERENCE TO RELATED APPLICATIONS

This application claims a benefit and priority to U.S. Provisional Patent Application Ser. No. 63/704,506, filed on Oct. 7, 2024, and U.S. Provisional Patent Application Ser. No. 63/741,706, filed on Jan. 3, 2025, each of which is hereby incorporated by reference in its entirety.

### BACKGROUND

An electro-hydrodynamic (EHD) air mover device, also known as an ionic fluid mover or ionic air mover, is an electronic device that in a normal operation induces movement of air (or, more generally, fluid - gas or liquid) that surrounds the EHD air mover device, by ionizing some of the surrounding air molecules and utilizing electromagnetic force to create the air flow without the use of mechanically moving components such as a fan or impellor blade.

This air flow can be referred to as an ionic wind. EHD air mover devices can be installed within larger electronic devices to provide a cooling airflow without the noise or vibration typically caused by mechanical air movers like axial fans. An EHD air mover device typically includes one or more emitter electrodes (or anodes), and one or more collector electrodes (or cathodes), where the emitter and collector electrodes are separated by a physical gap. In operation, low-current but high voltage power is applied to the emitter electrode, while the collector electrode is maintained at a lower voltage or even ground state. This voltage may be a positive bias. The voltage applied to the emitter electrode must be of sufficient magnitude to cause ionization of some nearby air molecules, but not so great as to exceed the breakdown voltage of air in the gap between emitter electrode and collector electrode. In this manner, an electrical filed gradient is created between the emitter and collector, which exerts an attractive force on the charged ions and so causes air flow, known as an ionic wind.

Being downstream in the airflow containing electrically charged ions, the collector electrode (e.g., collector electrode plates) of the EHD air mover device is also prone to attract and accumulate charged dust particles that may have been in the air. The operation of the EHD air mover device in dusty conditions can lead to the accumulation of dust on the collector electrode, which can degrade the effectiveness of the collector electrode due to debris covering over time that decrease the amount of the conductive surface of the collector electrode, diminishing its performance.

### SUMMARY

Embodiments of the present disclosure are directed to an apparatus for cleaning electrodes of an electro-hydrodynamic (EHD) air mover device, i.e., an electrode cleaning apparatus integrated with the EHD air mover device.

In accordance with one or more embodiments of the present disclosure, the electrode cleaning apparatus includes an emitter cleaning sliding scraper and a collector-cleaning slider scraper. In some embodiments, the cleaning scrapers are made of one or more non-conductive materials and placed on or adjacent to an emitter or collector electrode of the EHD air mover device. In some embodiments, the emitter cleaning scraper can be shaped as a bead that includes a hole through which an emitter electrode in the form of a wire passes, so that the cleaning bead is free to slide longitudinally along the wire of the emitter electrode. In some embodiments, the cleaning slider is made of at least one non-conductive material and is placed around or adjacent to a pair of plates of a collector electrode of the EHD air mover device so that the cleaning slider is free to slide longitudinally along the pair of plates of the collector electrode while contacting the collector electrode surface. In some embodiments, the cleaning slider can include a first cleaning slider placed around a first plate of the pair of plates, and a second cleaning slider placed around a second plate of the pair of plates.

### BRIEF DESCRIPTION OF THE DRAWINGS

FIG. 1 illustrates a process of fluid movement in an electro-hydrodynamic (EHD) fluid mover device, in accordance with one or more embodiments.

FIG. 2 illustrates a front view of an EHD air mover device, in accordance with one or more embodiments.

FIG. 3 illustrates a bottom view of an EHD air mover device, in accordance with one or more embodiments.

FIG. 4 illustrates a detailed view of components of an EHD air mover device, in accordance with one or more embodiments.

FIG. 5 illustrates an EHD air mover device with an emitter wire cleaner, in accordance with one or more embodiments.

FIG. 6 illustrates an emitter wire cleaner with a slit for insertion the emitter wire cleaner onto a wire of an emitter electrode of an EHD air mover device, in accordance with one or more embodiments.

FIG. 7 illustrates an emitter wire cleaner and a series of electromagnets for initiating a movement of the emitter wire cleaner, in accordance with one or more embodiments. Change FIG. 7. Change “Series of electromagnets” to “Series of electromagnetic coils arranged on a PCB with adjustable voltage, current and resulting magnetic field over time”. Remove the “N” inside arrows indicating magnet polarity.

FIG. 8A illustrates a cut-away cross-sectional view of a plate-style collector electrode of an EHD air mover device with an example non-conductive cleaning slider, in accordance with one or more embodiments.

FIG. 8B illustrates a cut-away cross-sectional view of a plate-style collector electrode of an EHD air mover device with another example non-conductive cleaning slider, in accordance with one or more embodiments.

FIG. 9A illustrates a cut-away cross-sectional view of a plate-style collector electrode of an EHD air mover device with a non-conductive cleaning slider, in accordance with one or more embodiments.

FIG. 9B is a perspective and schematic view of an emitter electrode scraper implemented as a vertical cleaning surface positioned to contact an emitter electrode mounted at the edge of a dielectric isolator, including a capture feature, slit or guide for alignment, and optional magnetic coupling to a collector slider.

FIG. 9C is a perspective view of a slider assembly contacting a collector electrode, the slider incorporating a permanent magnet positioned adjacent to a printed circuit board with traces forming three overlapping longitudinal coils.

FIG. 9D is a schematic view of a printed circuit board coil layout showing three coil phases arranged to generate a traveling magnetic field along the slider's length.

FIG. 9E is a timing diagram illustrating sequential energizing of the three coil phases used to produce continuous translation of the slider and scraper assembly along the electrodes.

FIG. 10 illustrates a system block diagram of an adaptive output power control for an EHD air mover device, in accordance with one or more embodiments.

FIG. 11 is a flowchart for a method of adaptive output power control for an EHD air mover device, in accordance with one or more embodiments.

FIG. 12 illustrates a block diagram of a power input control system for an EHD air mover device, in accordance with one or more embodiments.

FIG. 13A is a flowchart for a method of a two-stage power input and control for an EHD air mover device, in accordance with one or more embodiments.

FIG. 13B is a flowchart for a method of a three-stage power input and control for an EHD air mover device, in accordance with one or more embodiments.

FIG. 14A illustrates an embodiment of a coupled emitter-collector cleaning actuator in which a fork-like collector slider mechanically overlaps an emitter bead cleaner.

FIG. 14B illustrates an alternative embodiment of the collector slider and emitter bead overlap.

FIG. 14C illustrates a perspective view of an emitter bead mounted in a ceramic support structure, in accordance with one or more embodiments.

FIG. 14D illustrates a bead and slider structure in an assembled state with an emitter wire in place, in accordance with one or more embodiments.

FIG. 14E illustrates a cross-sectional view of a bead showing the internal bore through which the emitter wire extends, in accordance with one or more embodiments.

FIG. 14F illustrates a cross-sectional view of bead in relation to emitter wire, in accordance with one or more embodiments.

FIG. 14G illustrates an example bead incorporating a twisting helical inner hole, in accordance with one or more embodiments.

FIG. 14H shows an experimental image of the bead-wire region under energized conditions, in accordance with one or more embodiments.

FIGS. 14I and 14J illustrate simulated tangential electric field (TEF) distributions around different bead terminus geometries, in accordance with one or more embodiments.

FIG. 14K illustrates a cross-section view showing electric field vectors emanating from the emitter wire, in accordance with one or more embodiments.

FIG. 14L illustrates an example collector slider chassis, in accordance with one or more embodiments.

FIGS. 14M-14N are perspective view of a collector slider chassis showing coupling arms and the central magnet mounting region, in accordance with one or more embodiments.

FIG. 14O-14Q are different views of an emitter cleaning bead in accordance with one or more embodiments.

### DETAILED DESCRIPTION

### Introduction

During operation of the EHD air mover device, the emitter electrode may be subject to fouling due to the accumulation of debris on the emitter electrode from environmental contaminants. The source of the debris may include dust, volatile organic compounds (VOCs), and one or more other contaminants commonly found in air. In addition to simple accumulation of unwanted debris, such as dust, the EHD air mover device may also ionize some of the molecules that include such contaminants, causing the complex molecules to disassemble into smaller more basic molecules. For example, the VOCs may disassemble into nitrogen (N2), Oxygen (O2), water vapor (H2O), carbon dioxide (CO2) and/or silicon dioxide (SiO2).

The silicon dioxide is of a particular concern as the silicon dioxide tends to accumulate over time on a surface of the emitter electrode forming a thin amorphous layer initially, followed by crystalline structures, called dendrites, later. Silicon dioxide being insulative reduces the electric field near the emitter wire and thereby reduces the efficiency of the device in ionizing air molecules. The accumulation of dendrites on the surface of the emitter electrode can create irregular projecting points on the emitter electrode, causing a high electrical potential gradient at these locations of the emitter electrode. Additionally, the dendrites can decrease air gap distance between the emitter electrode and the collector electrode in a localized spot. Such dendrites can interfere with, diminish, or make non-uniform the electrical field between the emitter electrode and the collector electrode, such consistent electrical field being necessary to create a desired ionic wind within the EHD air mover device. Additionally, the dendrites can create locations on the emitter electrode where a voltage concentrates to the point where it may exceed the air gap breakdown voltage between the emitter electrode and collector electrode, thus causing an increased incidence of electrical discharge or arcs across the gap between the emitter electrode and the collector electrodes at such locations. When such arcing occurs, the intended operation of the EHD air mover device is momentarily halted.

Mitigating the problem caused by the fouling of the EHD air mover device due to environmental contaminants, particularly the accumulation of dendrites on the emitter electrode and dust on the collector electrode over the operational life of the EHD air mover device, has long been a challenge for creating reliable long service-life EHD air mover devices.

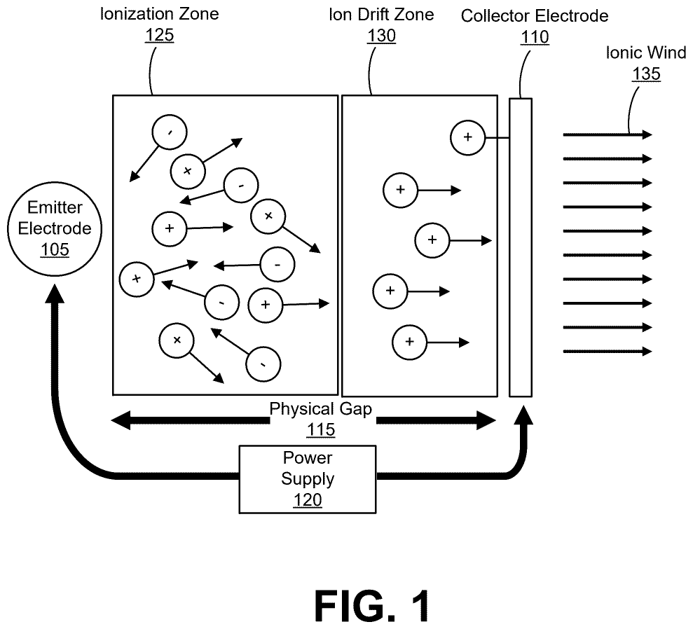

FIG. 1 illustrates a process of fluid movement (e.g., air movement) in an electro-hydrodynamic (EHD) fluid mover device 100, in accordance with one or more embodiments. The process of fluid movement in the EHD fluid mover device 100 can be achieved without any moving parts of the EHD fluid mover device 100. The EHD fluid mover device 100, also known as an ionic fluid mover or ionic air mover, is an electronic device that in a normal operation induces movement of fluid molecules that surround the EHD fluid mover device 100, typically air but may also be other gases or liquids, utilizing electromagnetic force to create such flow without the use of mechanically moving components. This flow can be referred to as an ionic wind.

As shown in FIG. 1, the EHD fluid mover device 100 may include an emitter electrode 105 (or anode) and a collector electrode 110 (or cathode) separated by a physical gap 115, e.g., an air gap. The EHD fluid mover device 100 may further include a power supply 120 that provides an electrical power required for operation of the EHD fluid mover device 100. By applying a sufficiently large differential voltage between the emitter electrode 105 and the collector electrode 110 via the power supply 120, an electrical field may be created between the emitter electrode 105 and the collector electrode 110. In one or more embodiments, a positive biased voltage of the power supply 120 is applied to the emitter electrode 105 (e.g., in the order of 2,500V to 5,000V), while the collector electrode 110 remains neutral or grounded. Alternatively, a negative biased voltage of the power supply 120 may be applied to the collector electrode 110.

The electrical field created in the physical gap 115 may need to be maintained at a sufficiently large magnitude to create an electrical field gradient between the emitter electrode 105 and the collector electrode 110 that is strong enough to partially ionize surrounding fluid molecules (e.g., air molecules) and create a plasma in a region in a vicinity of the emitter electrode 105, which is referred to as a corona discharge. The region having the partially ionized fluid molecules that create the corona discharge is illustrated in FIG. 1 as an ionization zone 125. It should be noted that the electrical field created in the physical gap 115 should be set not to be too large to exceed a dielectric breakdown voltage of the physical gap 115. Exceeding the dielectric breakdown voltage of the physical gap 115 by the electrical field would cause a sudden electrical current (e.g., arc or spark) between the emitter electrode 105 and the collector electrode 110 due to a short circuit established across the physical gap 115. Alternatively or additionally, exceeding the dielectric resistance of the physical gap 115 by the electrical field may cause a flow of electrical current along a surface of any non-conductive structure that is between the emitter electrode 105 and the collector electrode 110. This flow of electrical current can be referred to as an electrical creep, and the shortest path distance between any conductors of the EHD fluid mover device 100 can be referred to as a creep distance.

Ionized molecules (e.g., positively ionized molecules) created in the area of corona discharge (i.e., in the ionization zone 125) may be accelerated toward the collector electrode 110 via an electromagnetic force exerted by the electrical field. Hence, an ion drift zone 130 with the ionized molecules may be created in a vicinity of the collector electrode 110. Enroute to the collector electrode 110 and in the ion drift zone 130 the ionized molecules may collide with surrounding neutral fluid molecules and impart momentum on the neutral molecules, thus creating the net fluid movement which is detected as a pressure head and flow similar to that produced by a mechanical fan, which can be referred to as an ionic wind 135. The generated ions eventually pass their charge to nearby areas of lower potential or recombine to form neutral gas molecules again.

The corona discharge may be positive or negative, determined by the polarity of the voltage applied to each electrode of the EHD fluid mover device 100, which have different underlying properties associated with their respective predominant electrical bias (i.e., positive, or negative). In one or more embodiments, the EHD fluid mover device 100 in a normal operation utilizes a large positive voltage applied to the emitter electrode 105 (e.g., shaped as a wire), while the collector electrode 110 is neutral or ground, and thus creates a positive corona discharge. The positive corona discharge is strongly favored for normal operations of small-factor EHD fluid mover devices intended for use within confined volumes, such as internal to an electronic consumer device to create a cooling airflow. This is because, as compared to negative corona discharge, the positive corona discharge can be created in preferred small geometries and has other advantages such as a lower creation rate of ozone molecules when operating in the air.

The corona discharge can form at locations near the high voltage emitter electrode 105 where the electrical field potential gradient is the highest - at sharp points or at regions of small radii on the emitter electrode 105, such as sharp corners or edges, projecting points, or small diameter wires where the high curvature causes a high potential gradient at these locations. In one or more embodiments, the EHD fluid mover device 100 utilizes a small radius wire-type emitter electrode 105, so as to establish a corona discharge along the length of the wire electrode and thus induce ionic flow along the entire length dimension of the EHD fluid mover device 100 where the emitter electrode 105 is exposed to a surrounding fluid (e.g., air).

A state of an impeded operation of the EHD fluid mover device 100 may occur when the desired ionic flow within the physical gap 115 ceases, i.e., when the normal positive ion flow from the emitter electrode 105 to the collector electrode 110 is dominated by a sudden electron flow (i.e., electrical current) between the collector electrode 110 and the emitter electrode 105, which is known as an arc, spark, or short circuit. During such an arc event, the relative voltage differential between the emitter electrode 105 and the collector electrode 110 collapses due to the low impedance of an arc, which in turn would stop the coronal discharge, and thus no ionic pressure head or flow is created by the EHD fluid mover device 100 during such arcing state. To allow for the stable control of the electrical field and mitigate the risk of arcing within the EHD air mover device 100, a certain minimum gap or distance between any portion of the emitter electrode 105 and a nearest portion of the collector electrode 110 may need to be maintained.

In the normal operation of the EHD fluid mover device 100, the electrical field must be maintained at a level strong enough to ionize molecules of the fluid near the emitter electrode 105 (i.e., to form the ionization zone 125), but below a natural dielectric breakdown voltage of the fluid in the physical gap 115 (e.g., approximately 3 kV/mm for air, or some other limit as determined by the dielectric breakdown of an alternate surrounding fluid), so as not to cause a current discharge or arc between the emitter electrode 105 and the collector electrodes 110 across the physical gap 115. Additionally, a minimum gap or distance between any portion of the emitter electrode 105 and a nearest portion of the collector electrode 110 needs to be maintained at a precise distance to allow for the stable control of the electrical field thus mitigating the risk of arcing.

Accordingly, specific factors need to be considered when designing the EHD fluid mover device 100, including but not limited to: (i) the precise mechanical positioning and physical stability of the emitter electrode 105 and the collector electrode 110 in relation to each other to maintain the desired distance between the emitter electrode 105 and the collector electrode 110, and thus enable predictable operation of the EHD fluid mover device 100 without any arcing; and (ii) the measurement and control of the power being supplied to the emitter electrode 105 to optimize a strength of the electrical field between the emitter electrode 105 and the collector electrode 110, as well as to mitigate and/or respond to changing conditions which can result in a changed likelihood of arcing.

As aforementioned, the operation of the EHD fluid mover device 100 requires establishing an electrical field gradient between the emitter electrode 105 and the collector electrode 110, which can be achieved by applying a large differential voltage between the emitter electrode 105 and the collector electrode 110. For example, during the normal operation of the EHD fluid mover device 100, the emitter electrode 105 can typically have a voltage applied in the order of 2,500V to 6,000V, while the collector electrode 110 remains neutral or grounded. Due to the strong electrical field between the emitter electrode 105 and the collector electrode 110, the normal operation of the EHD fluid mover device 100 may require an isolation between the emitter electrode 105 and the collector electrode 110 to minimize or at least reduce inadvertent short circuits caused by the flow of electrical charge along the shortest path along the outer surface of an otherwise generally non-conductive material between two locations of high differential electrical potential (i.e., electrical creep). Containing the electrical field within a non-conductive housing, and/or robust grounding or shielding of all external conductive components near the EHD fluid mover device 100 may be required to eliminate the possibility of imparting a harmful electrical charge onto external device components near the EHD fluid mover device 100, which can lead to damaging short circuits or arcs between the high-voltage elements of the EHD fluid mover device 100 (e.g., the high-power boost stage of the power supply 120, or the emitter electrode 105 when operating under high voltage) and conductive external components within an electronic device in which the EHD fluid mover device 100 is installed.

To minimize or at least reduce a total power consumed by the EHD fluid mover device 100, so as to enable the EHD fluid mover device 100 to operate within a battery-powered electronic device without adversely affecting overall battery life as compared to a typical axial fan, the EHD fluid mover device 100 should consume no more than between 1W and 2W of the total power during the normal operation. At the required voltage and power levels for the normal operation of the EHD fluid mover device 100, the power supply 120 may need to be able to provide the voltage to the emitter electrode 105 in the order of 2,500V to 5,000V, and at an electrical current in the order of 10 mA to 40 mA. To operate the EHD fluid mover device 100 in a typical consumer electronic device, an input power rail to the EHD fluid mover device 100 should be between 5V and 24V. Therefore, the power supply 120 needs to be able to accept a low voltage input in the order of 5V to 24V, output a high voltage very low current power, in the order of 2,500V to 5,000V at 60 mA to 30 mA, for a total power that is less than 2W. Additionally, the power supply 120 may require to be dynamically controlled for adapting to detected rates of arcing caused by changes in the dielectric breakdown level of the air or other surrounding fluid in the physical gap 115, changes in a distance between the emitter electrode 105 and the collector electrode 110, contaminants on the emitter electrode 105 and the collector electrode 110 that may cause localized concentration of the electrical field, some other conditions that can lead to arcing, or some combination thereof.

### Electro-Hydrodynamic Air Mover Device

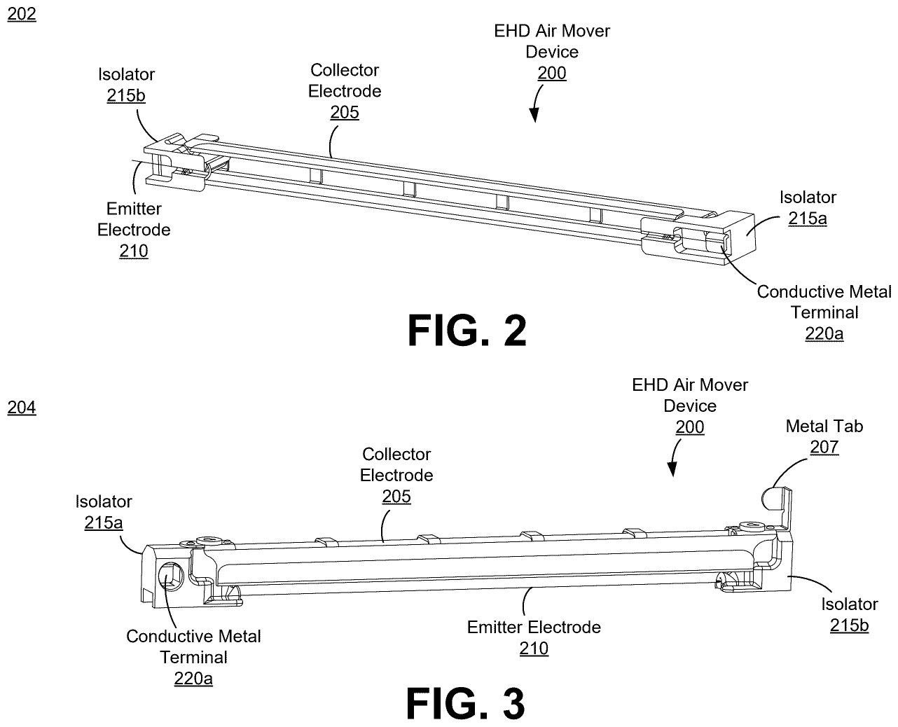

FIG. 2 illustrates a front view 202 of an electro-hydrodynamic (EHD) air mover device 200, in accordance with one or more embodiments. The EHD air mover device 200 may include a collector electrode 205, an emitter electrode 210, an isolator 215a, and an isolator 215b. The EHD air mover device 200 may include one or more additional components not shown in FIG. 2. In general, the EHD air mover device 200 may include features for mounting and aligning electrodes to optimize performance, including spring-loaded conductive terminals and structural end caps with ribs and lips for secure placement. The EHD air mover device 200 may be an embodiment of the EHD fluid mover device 100.

The collector electrode 205 and the emitter electrode 210 may be attached to and held in a preferred position by the isolators 215a, 215b. The isolators 215a, 215b may be in the form of insulating end caps, located at longitudinal ends of the collector electrode 205 and the emitter electrode 210. The isolators 215a, 215b may be made of one or more non-conductive materials.

An air gap and spatial alignment between the collector electrode 205 and the emitter electrode 210 may be maintained by the isolators 215a, 215b. Precise positioning of the isolators 215a, 215b may ensure an adequate creep distance and air gap between the collector electrode 205 and the emitter electrode 210 in order to prevent electrical arcing within the EHD air mover device 200. In this manner, the corona discharge and resulting ionic flow of the EHD air mover device 200 can be more easily maintained at a desired power level without interruption by arcing that could result from the air gap distance between the collector electrode 205 and the emitter electrode 210 reduced below a threshold distance (e.g., creep distance) at any point in space or time.

FIG. 3 illustrates a bottom view 204 of the EHD air mover device 200, in accordance with one or more embodiments. The isolator 215a may include a slot for a conductive metal terminal 220a (e.g., positive high-voltage terminal, or HV+terminal). As shown in FIG. 2, the isolator 215b may also include a slot for a conductive metal terminal 220b (e.g., the opposite end attach point for the positive high-voltage terminal, or HV+ terminal). A slot for the conductive metal terminal 220a, may have an access within the isolator 215a to allow access to an orthogonal surface of the conductive metal terminal 220a.

The conductive metal terminal 220a may be utilized to attach one end of the emitter electrode 210 (e.g., wire) via a solder or weld connection, and the conductive metal terminal 220b may be utilized to attach the other end of the emitter electrode 210 via another solder or weld connection. At least one end of the collector electrode 205 may include a metal tab 207 extending in a direction away from the emitter electrode 210. The metal tab 207 may be used as an electrical contact point for the collector electrode 205 to the power supply (e.g., the negative high-voltage, or HV−) and/or to the ground.

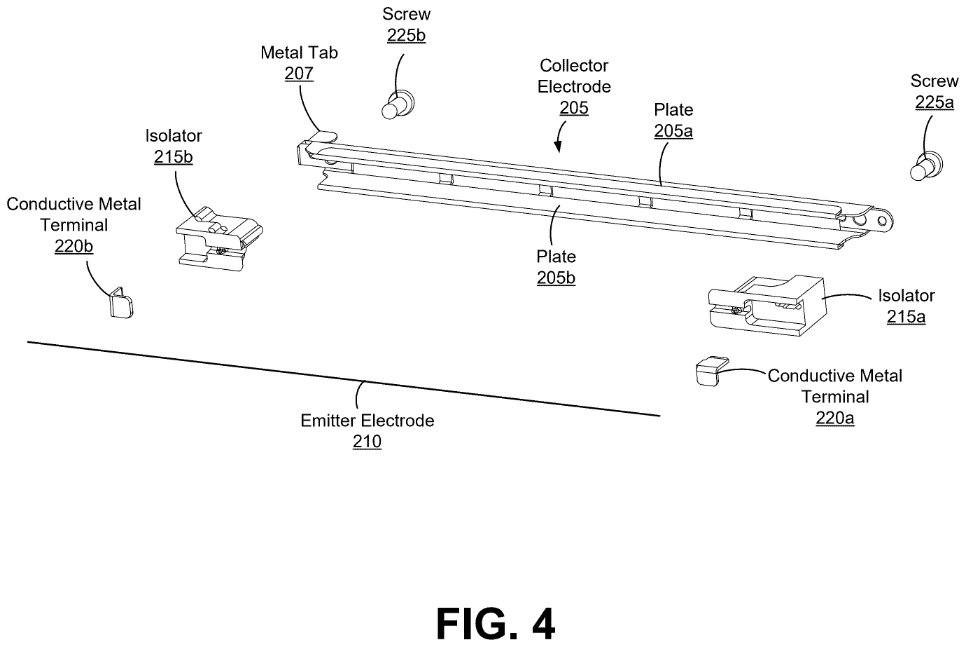

FIG. 4 illustrates a detailed view 206 of components of the EHD air mover device 200, in accordance with one or more embodiments. In addition to components shown in FIGS. 2-3, the EHD air mover device 200 may further include a pair of screws 225a, 225b. The screw 225a may be used to connect the collector electrode 205 to the isolator 215a, and the screw 225b may be used to connect the collector electrode 205 to the isolator 215b. The emitter electrode 210 may be implemented as an emitter wire. One longitudinal end of the emitter electrode 210 may be connected to the conductive metal terminal 220a (e.g., positive high-voltage terminal, or HV+ terminal), and the other longitudinal end of the emitter electrode 210 may be connected to the conductive metal terminal 220b (e.g., negative high-voltage terminal, or HV− terminal).

Additionally, FIG. 4 shows the collector electrode 205 that includes a pair of parallel plates, i.e., plates 205a, 205b.

Each conductive metal terminal 220a, 220b may have a flat surface of a sufficient size. The flat surface of each conductive metal terminal 220a, 220b may be made of one or more conductive materials that facilitate firmly attaching a wire of the emitter electrode 210 to each conductive metal terminal 220a, 220b via a solder or weld or other connection (not shown in FIG. 4) to hold the wire of the emitter electrode 210 in place and under an appropriate tension when the EHD air mover device 200 is assembled. The tension may be sufficient to minimize or at least reduce sagging of the emitter electrode 210 and/or excess movement of the emitter electrode 210, which would alter the air gap distance from the collector electrode 205 to the emitter electrode 210 and potentially induce arcing within the EHD air mover device 200.

### Electrode Cleaning Apparatus

During the operation of the EHD air mover device 200, an accumulation of surface contaminants is common, so occasional cleaning may provide for improved operation and lifetime reliability. Embodiments of the present disclosure are directed to an electrode cleaning apparatus, and more particularly to a cleaning scraper for removing dust and debris from the emitter electrode 210 and cleaning sliders for removing dust and debris from the collector electrode 205. Embodiments of the present disclosure are further directed to various mechanisms to induce cleaning motions of the electrode cleaning apparatus, such as mechanisms that utilize electromagnetic forces and piezoelectric vibrations.

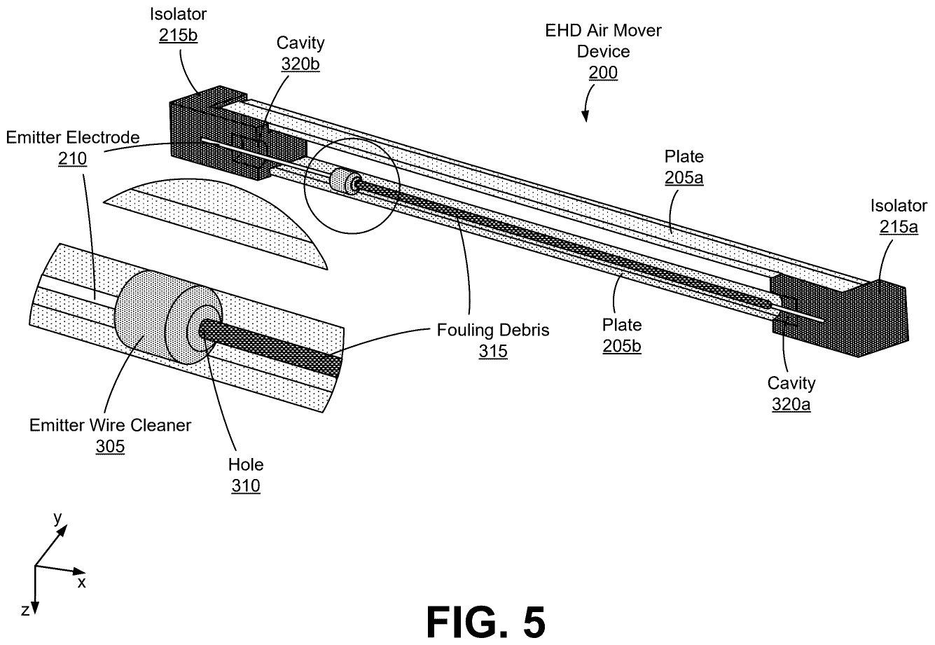

FIG. 5 illustrates the EHD air mover device 200 with an emitter wire cleaner 305, in accordance with one or more embodiments. The emitter wire cleaner 305 may be implemented as a cleaning bead made of one or more non-conductive materials. The emitter wire cleaner 305 may include a hole 310 through which the emitter electrode 210 (i.e., wire) passes, such that the emitter wire cleaner 305 is free to slide longitudinally along the emitter electrode 210 (e.g., along the x axis) and scrape off accumulated fouling debris 315, including but not limited to dust or SiO2 dendrites. FIG. 5 shows a portion of the emitter electrode 210 scrapped clean of fouling debris and/or dendrites, a portion of the emitter electrode 210 with debris and/or dendrite fouling accumulated on a surface of the emitter electrode 210, the parallel plates 205a, 205b of the collector electrode 205, and the isolators 215a, 215b.

The construction, weight, and dimensions of the emitter wire cleaner 305 (i.e., bead) may have the following properties. The emitter wire cleaner 305 may have a sufficient weight that under the normal usage of an electronic system/electronic device into which the EHD air mover device 200 is installed, the emitter wire cleaner 305 may experience motion along the length of the emitter electrode 210 (i.e., along a length of the emitter wire) when the electronic system/electronic device moves, vibrates, rotated or accelerates. The emitter wire cleaner 305 may be constructed of one or more non-conducting materials to reduce the likelihood of short circuiting or arcing among elements of the EHD air mover device 200, and/or between the EHD air mover device 200 and any external components of the electronic system/electronic device into which the EHD air mover device 200 would be installed.

The hole 310 and/or an inner surface of the emitter wire cleaner 305 through which the emitter electrode 210 passes may be large enough to allow the emitter wire cleaner 305 to freely move along the length of the emitter electrode 210, but not so large as to create a space between the inner surface of the emitter wire cleaner 305 and the emitter electrode 210 that would prevent creating a sufficient friction to dislodge debris accumulated on the surface of the emitter electrode 210. External dimensions of the emitter wire cleaner 305 may be small enough so as to prevent inadvertent arcing or short circuiting between the emitter electrode 210 and any surrounding surface, including maintaining a sufficient creep distance along the surface of the emitter wire cleaner 305 and a gap through the air to prevent emitter-to-collector arcing.

No elements may be positioned along the moving path of the emitter wire cleaner 305 such that the emitter wire cleaner 305 does not lodge itself in a fixed position, nor make permanent contact with any obstructions along the length of the intended movement over the wire of the emitter electrode 210. As aforementioned, the isolators 215a, 215b may be used to attach the emitter electrode 210 and the collector electrode 205 and hold them in a desired position relative to each other. As shown in FIG. 5, the isolators 215a, 215b may include cavities 320a, 320b. Each cavity 320a, 320b may be sufficiently large for the emitter wire cleaner 305 (i.e., non-conductive cleaning bead) to reside at either end of the emitter electrode 210, so that a desired creep distance to prevent a flow of electrical current over the surface of the emitter wire cleaner 305 and the corresponding isolator 215a, 215b is maintained to avoid the flow of electrical current between the emitter electrode 210 and the collector electrode 205 during all phases of the normal operation of the EHD air mover device 200, e.g., start-up phase, operating phase, and shut-down phase.

During the operation of the electronic system/electronic device into which the EHD air mover device 200 is installed, any normal vibration, jostling, rotation, and/or acceleration as a result of normal use, rotation, and transportation may induce a movement of the emitter wire cleaner 305 due to its independence of linkage to the wire of the emitter electrode 210. This movement of the emitter wire cleaner 305 may cause the inner portion of the emitter wire cleaner 305 to scrape, or frictionally slide along the inner or outer edge of the emitter electrode 210, and such contact would serve to slightly agitate the surface of the emitter electrode 210. The natural action of the movement of the emitter wire cleaner 305 as a result of a bead construction, weighting, shape, and dimensions may provide such an agitation and result in the removal or clearing of accumulated material and restore the original operation of the EHD air mover device 200.

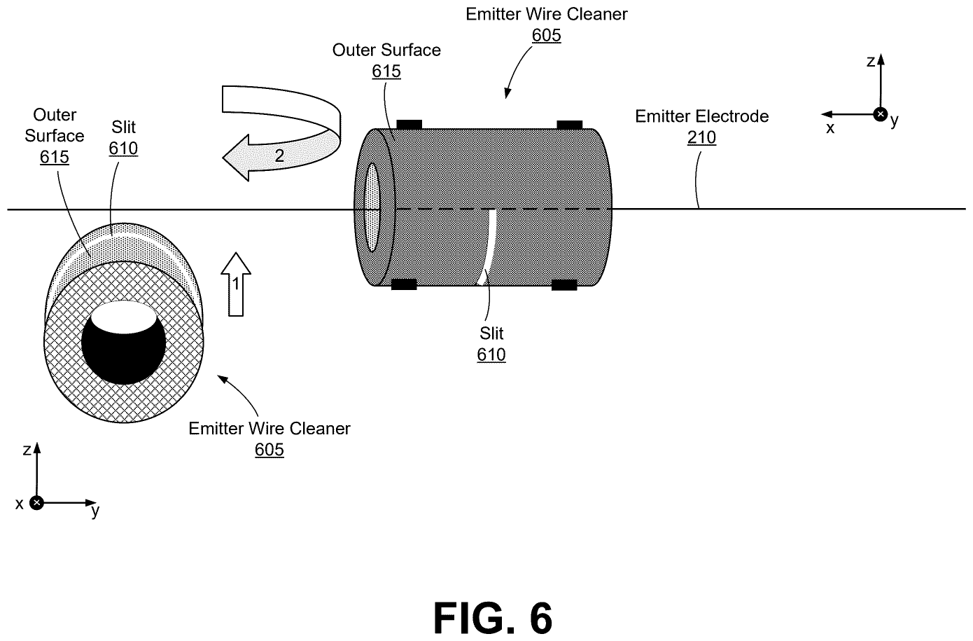

FIG. 6 illustrates an emitter wire cleaner 605 with a slit 610 for insertion of the emitter wire cleaner 605 onto the wire of the emitter electrode 210, in accordance with one or more embodiments. The emitter wire cleaner 605 may be an embodiment of the emitter wire cleaner 305. To facilitate the installation of the emitter wire cleaner 605 onto the emitter electrode 210, it is desirable to have a means of affixing the emitter wire cleaner 605 to the emitter electrode 210 without having to needle onto the emitter electrode 210 at initial assembly. To facilitate this, the slit 610 can be created on an outer surface 615 of the emitter wire cleaner 605 (e.g., top portion of the emitter wire cleaner 605) that allows installation of the emitter wire cleaner 605 by simply placing the emitter electrode 210 through the slit 610, and then twisting the emitter wire cleaner 605 onto the emitter electrode 210. As shown in FIG. 6, at the first installation step, the slit 610 in the emitter wire cleaner 605 is aligned to the wire of the emitter electrode 210 and slid up. At the second installation step, the emitter wire cleaner 605 is twisted to align the emitter wire cleaner 605 to the emitter electrode 210 longitudinally, e.g., along the x axis. The installation process can be performed automatically via an assembly device or can be accomplished manually.

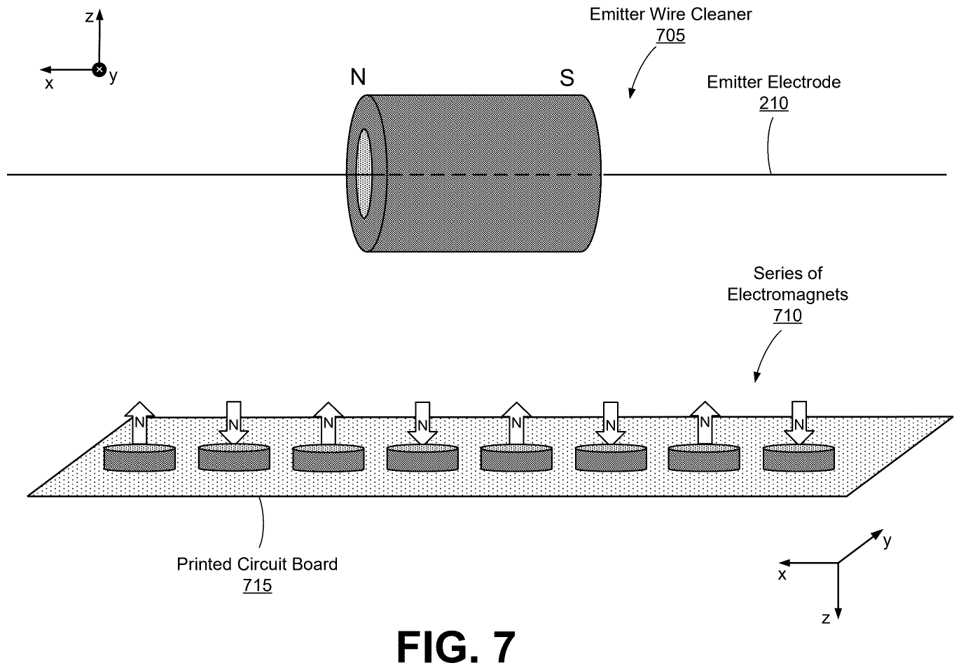

FIG. 7 illustrates an emitter wire cleaner 705 and a series of electromagnets 710 for initiating a movement of the emitter wire cleaner 705, in accordance with one or more embodiments. The emitter wire cleaner 705 may be an embodiment of the emitter wire cleaner 305. A composition of the emitter wire cleaner 705 may be magnetically reactive, i.e., the emitter wire cleaner 705 may include one or more magnetic materials that react to an externally applied magnetic field. This may allow for a periodic ‘push’ and ‘pull’ force applied in the region near the emitter electrode 210 which would initiate a motion of the emitter electrode cleaner 705 along a length of the emitter electrode 210.

The series of electromagnets 710 may be created via traces of wire on a multi-layer printed circuit board (PCB) 715 onto which the EHD air mover device 200 is mounted for integration into an electronic device. The series of overlapping PCB traces, which form longitudinal coils can create a ‘fringing effect’ of magnetic lines of force that can repel or attract a properly oriented magnetic element, or in this case, nudge the emitter wire scraper and slider assembly laterally left or right along the surface of the emitter electrode and collector electrode, respectively.

A direction of the magnetic field of the one or more magnetic materials of the emitter electrode cleaner 705 may contain a magnetic ‘moment’ along the x axis. The series of low profile, linearly arranged, close proximity electromagnets 710, formed by wire coils, can be driven to create a magnetic field which can push the emitter wire cleaner 705 in a right-ward or left-ward direction along the x axis, or each direction in succession. Each movement of the emitter wire cleaner 705 across the length of the emitter electrode 210 can allow the removal of debris from the emitter electrode 210, thus extending the normal operation of the EHD air mover device 200.

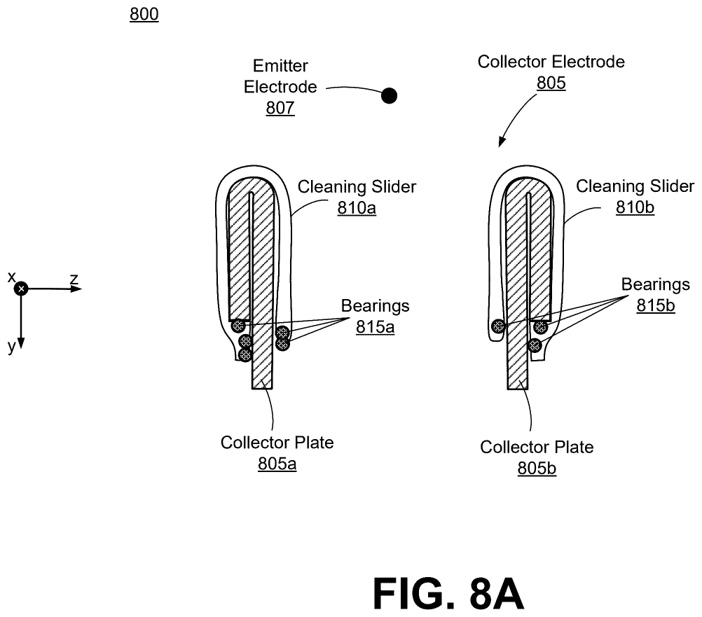

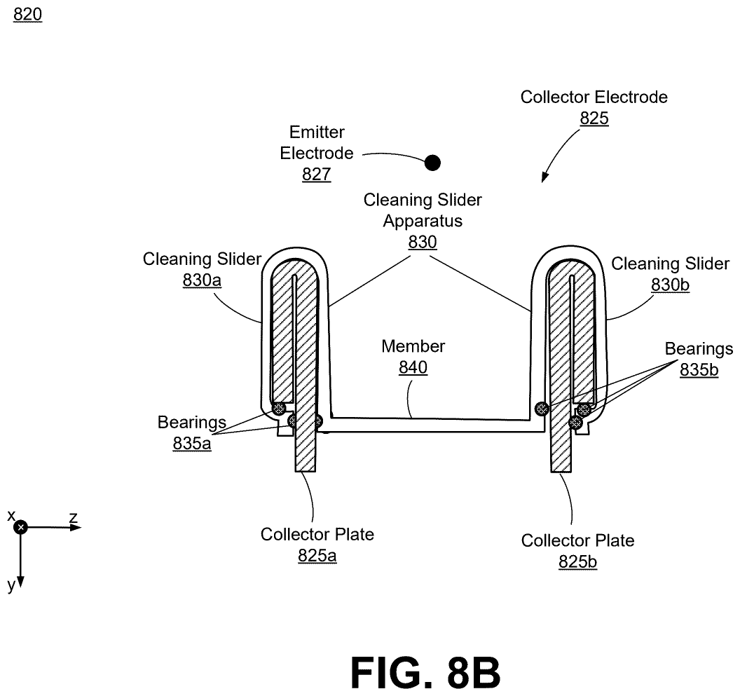

FIG. 8A illustrates a cut-away cross-sectional view 800 of a plate-style collector electrode 805 of an EHD air mover device (e.g., the EHD air mover device 200) with cleaning sliders 810a, 810b, in accordance with one or more embodiments. The plate-style collector electrode 805 may be an embodiment of the collector electrode 205. The cleaning sliders 810a, 810b may be made of one or more non-conductive materials. Each cleaning slider 810a, 810b may be formed around a corresponding collector plate 805a, 805b of the collector electrode 805. Each cleaning slider 810a, 810b may utilize a lip at an end portion of the collector plate 805a, 805b to help prevent lifting of the cleaning slider 810a, 810b away from a surface of the collector plate 805a, 805b intended to be cleaned. Each cleaning slider 810a, 810b may include one or more bearings 815a, 815b (e.g., small ball bearings) to help ensure smooth sliding of the cleaning sliders 810a, 810b along a length of the collector electrode 805 and scraping off accumulated fouling debris from the collector plates 805a, 805b, including but not limited to dust.

The construction, weight, and dimensions of each cleaning slider 810a, 810b can be such that it has the following properties. Each cleaning slider 810a, 810b may have a sufficient weight that under the normal usage of an electronic system/electronic device into which the EHD air mover device 200 is installed, each cleaning slider 810a, 810b may experience a motion along the length of the collector plate 805a, 805b when the electronic system/electronic device moves, vibrates, rotates or accelerates. Each cleaning slider 810a, 810b may be constructed of one or more non-conducting materials to reduce the likelihood of short circuiting or arcing among elements of the EHD air mover device 200, and/or between the EHD air mover device 200 and any external components of the electronic system/electronic device into which the EHD air mover device 200 would be installed.

An inner surface of each cleaning slider 810a, 810b through which the corresponding collector plate 805a, 805b passes may be large enough to allow each cleaning slider 810a, 810b to freely move along the length of the corresponding collector plate 805a, 805b, but not so large as to create a space between the inner surface of each cleaning slider 810a, 810b and the corresponding collector plate 805a, 805b that would interfere materially with the movement of the corresponding cleaning slider 810a, 810b and ability of the corresponding cleaning slider 810a, 810b to dislodge dust and debris accumulated on the surface of the corresponding collector plate 805a, 805b. External dimensions of each cleaning slider 810a, 810b may be small enough so as to prevent inadvertent arcing or short circuiting between an emitter electrode 807 and any surrounding surface, including maintaining a sufficient creep distance along the surface of each cleaning slider 810a, 810b and a gap through the air to prevent emitter-to-collector arcing. The emitter electrode 807 may be an embodiment of the emitter electrode 210.

No elements may be positioned along the moving path of each cleaning slider 810a, 810b such that each cleaning slider 810a, 810b does not lodge itself in a fixed position, nor make permanent contact with any obstructions along the length of the intended movement along the corresponding collector plate 805a, 805b. As aforementioned in relation to FIGS. 2-4, the EHD air mover device 200 includes the isolators 215a, 215b (e.g., isolator caps) with cavities that can be used to attach the emitter electrode 210 and the collector electrode 205 and hold them in a desired position relative to each other. A cavity of each isolator cap may be sufficiently large for each cleaning slider 810a, 810b to reside at either end of the corresponding collector plate 805a, 805b, so that a desired creep distance to prevent a flow of electrical current over the surface of each cleaning slider 810a, 810b and the isolator cap is maintained to avoid the flow of electrodes during all phases of operation of the EHD air mover device 200, e.g., start-up phase, operating phase, and shut-down phase.

FIG. 8B illustrates a cut-away cross-sectional view 820 of a plate-style collector electrode 825 of an EHD air mover device (e.g., the EHD air mover device 200) with a cleaning slider apparatus 830 including cleaning sliders 830a, 830b, in accordance with one or more embodiments. The plate-style collector electrode 825 may be an embodiment of the collector electrode 205. The cleaning sliders 830a, 830b may be made of one or more non-conductive materials. Each cleaning slider 830a, 830b may be formed around a corresponding collector plate 825a, 825b of the collector electrode 825. Each cleaning slider 830a, 830b may utilize a lip of an end portion of the collector plate 825a, 825b to help prevent lifting of each cleaning slider 830a, 830b away from a surface of the collector plate 825a, 825b intended to be cleaned. Each cleaning slider 830a, 830b may include one or more bearings 835a, 835b (e.g., small ball bearings) to help ensure smooth sliding of the cleaning sliders 830a, 830b along a length of the collector electrode 825 and scraping off accumulated fouling debris from the collector plates 825a, 825b, including but not limited to dust.

The cleaning slider 830a may be connected to the cleaning slider 830b via a member 840 (or connector). The member 840 may be made of one or more non-conductive materials. The member 840 may increase an overall mass of the cleaning slider apparatus 830 and facilitate movements and operations of the cleaning sliders 830a, 830b along both surfaces of the collector plates 825a, 825b as a unit. In this manner, the cleaning sliders 830a, 830b can clean both collector plates 825a, 825b at the same time.

In one or more embodiments, a connector (not shown in FIG. 8B) connects the cleaning sliders 830a, 830b on two parallel adjacent collector plates 825a, 825b and an emitter cleaning scraper (e.g., the emitter electrode cleaner 305) on an emitter electrode 827. The scraper on the emitter electrode 827 may be the emitter electrode cleaner 305, and the emitter electrode 827 may be an embodiment of the emitter electrode 210. In such cases, an electrode cleaning apparatus including the collector cleaning sliders 830a, 830b and the emitter cleaning scraper may move along and clean a wire of the emitter electrode 827 and the collector plates 825a, 825b at the same time. The connector between the emitter cleaning bead and the collector cleaning sliders 830a, 830b may be of a sufficient surface distance to exceed the creep distance between the emitter electrode 827 and the collector plates 825a, 825b to prevent arcing.

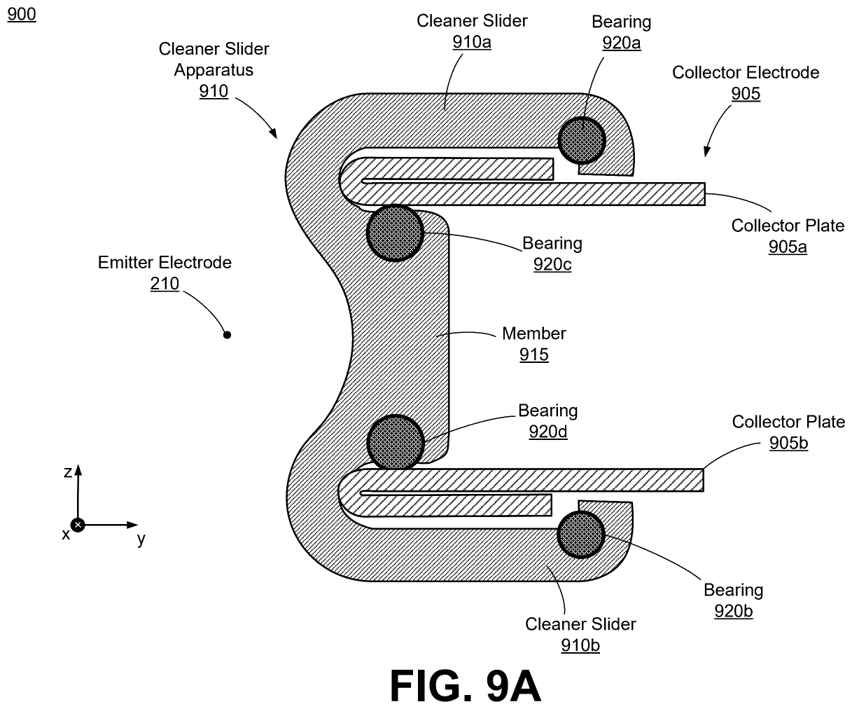

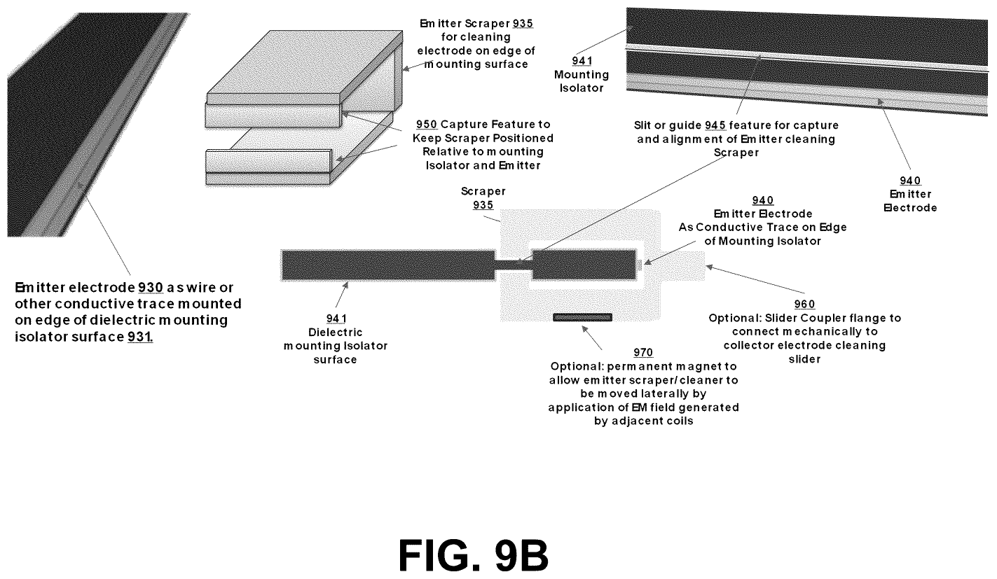

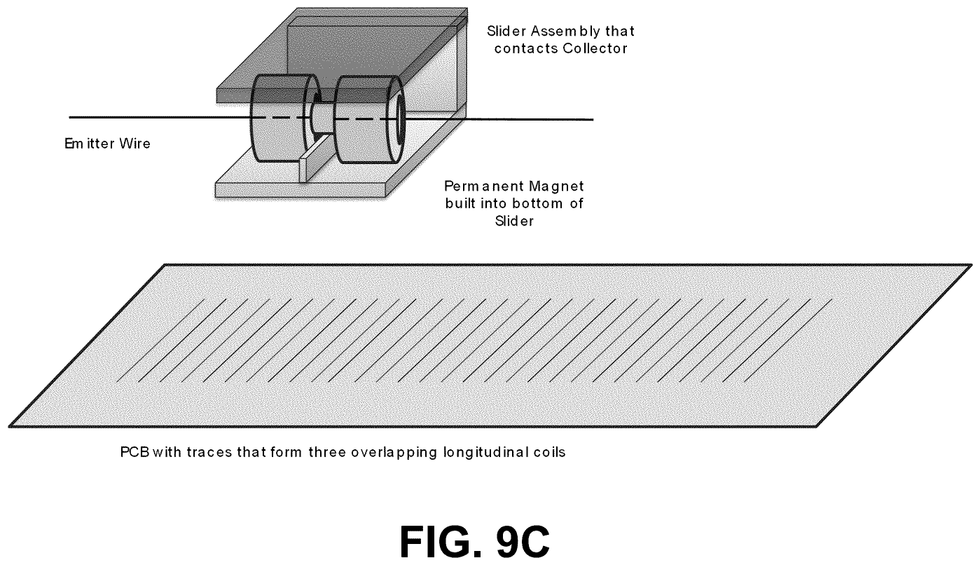

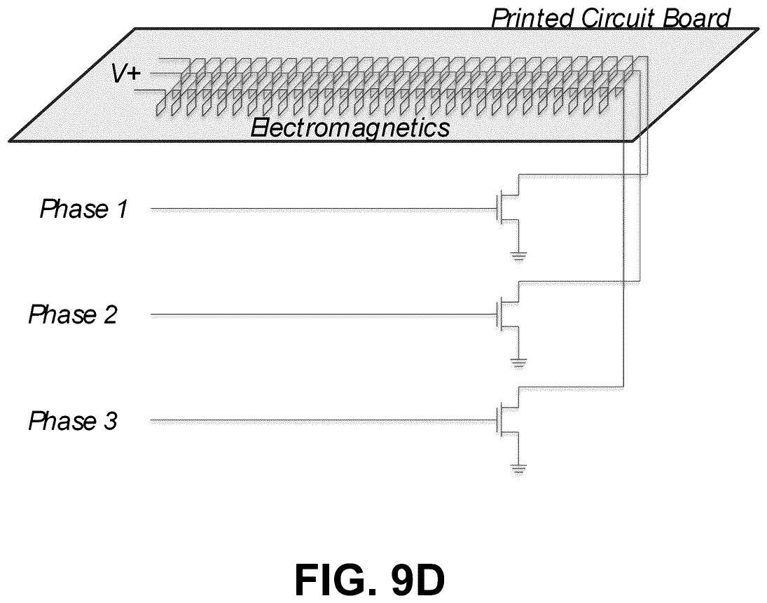

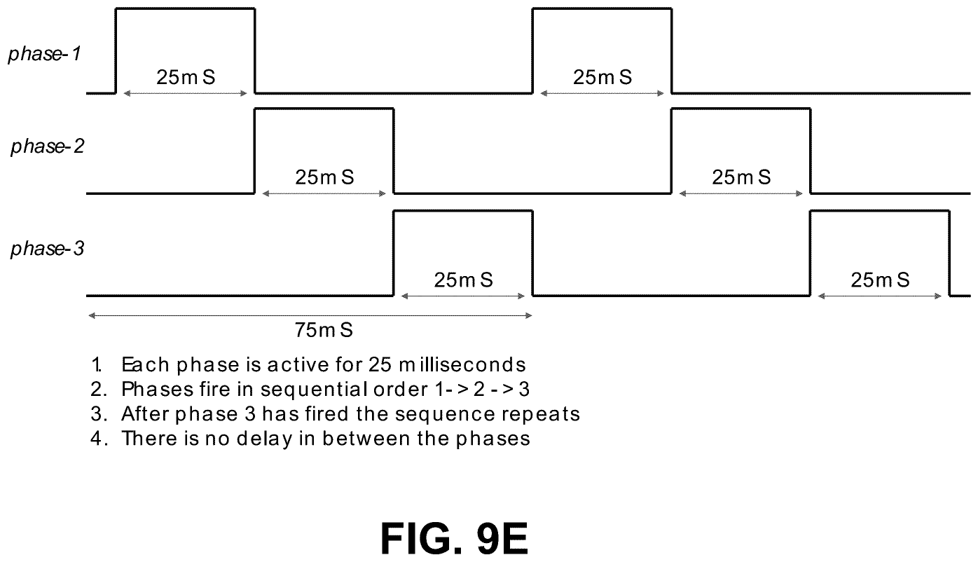

FIG. 9A illustrates a cut-away cross-sectional view 900 of a plate-style collector electrode 905 of an EHD air mover device (e.g., the EHD air mover device 200) with a non-conductive cleaning slider apparatus 910, in accordance with one or more embodiments. The plate-style collector electrode 905 may be an embodiment of the collector electrode 205, and the cleaning slider apparatus 910 may be an embodiment of the cleaning slider apparatus 830. The plate-style collector electrode 905 may include a pair of parallel collector plates 905a, 905b. The cleaning slider apparatus 910 may include a cleaning slider 910a placed on the collector plate 905a, a cleaning slider 910b placed on the collector plate 905b, and a member 915 connecting the cleaning slider 910a with the cleaning slider 910b. The cleaning slider 910a may include a bearing 920a, the cleaning slider 910b may include a bearing 920b, and the member 915 may include a pair of bearings 920c, 920d. The bearings 920a, 920b, 920c, 920d may help ensure smooth sliding of the cleaning slider apparatus 910 along a length of the collector electrode 905 and scraping off accumulated fouling debris from the collector plates 905a, 905b, including but not limited to dust.

In some embodiments, the emitter electrode is not necessarily implemented as a suspended wire stretched between oppositely disposed mounts. Instead, the emitter electrode may be formed as a conductive edge or elongate conductive trace positioned along an edge of a dielectric mounting isolator surface. In such arrangements, the emitter electrode is supported by and integrated with the isolator structure, presenting an exposed conductive edge to the surrounding airflow path. A cleaning element, such as a scraper or bead, can be shaped to engage the conductive edge profile and remove deposits that accumulate on the emitter surface during operation, while maintaining sufficient dielectric separation from adjacent conductive components to reduce the risk of electrical arcing.

FIG. 9B illustrates an embodiment of an emitter electrode cleaning scraper 935 configured to remove contaminants from an emitter electrode 940 mounted along the edge of a dielectric mounting isolator surface 941. In this embodiment, the emitter electrode 940 may be implemented as a conductive wire or conductive trace fixed to the longitudinal edge of the mounting isolator 941.

The emitter scraper 935 presents a vertical cleaning surface positioned to maintain contact with the emitter electrode 940 during longitudinal movement along the mounting structure 941. A capture feature 950 formed in the scraper 935 engages a corresponding slit or guide 945 on the mounting isolator 941. This engagement retains the scraper 935 in the correct lateral and vertical position relative to the emitter electrode 940 and prevents displacement away from the electrode surface during operation.

In some embodiments, the scraper 935 includes a slider coupling flange 960 configured to mechanically connect to a collector electrode cleaning slider. This coupling allows the emitter scraper 935 and a collector cleaning slider to move together along their respective electrodes while maintaining required electrical separation.

In optional embodiments, a permanent magnet 970 is integrated into the scraper 935. The magnet 970 enables the scraper to be translated laterally along the emitter electrode 940 in response to an electromagnetic field applied by one or more adjacent coils mounted on a printed circuit board. This magnetic actuation may be used independently or in coordination with movement of a collector electrode cleaning slider.

FIG. 9C illustrates an embodiment of a slider and scraper assembly configured for electromagnetic actuation. A slider assembly is positioned to contact and clean a surface of a collector electrode, while a separate scraper element is positioned to clean debris from an emitter wire. The slider and scraper are mechanically coupled in a manner that allows movement of one to induce corresponding movement of the other, yet remain structurally independent so that each maintains appropriate electrical isolation.

The slider contains a permanent magnet embedded in its lower surface. The magnet is positioned adjacent to a printed circuit board (PCB) carrying a set of low-profile traces arranged along the length of the PCB. These traces form multiple overlapping longitudinal electromagnetic coils. When driven, the coils produce a controlled magnetic field in proximity to the embedded magnet, thereby inducing a lateral force on the slider and scraper assembly. This force causes the assembly to travel across the surfaces of the emitter wire and collector elements, scraping or wiping debris from those surfaces to extend operational performance of the EHD air mover device.

FIG. 9D illustrates an example printed circuit board layout for generating the lateral magnetic field. The PCB is fabricated with conductive traces arranged into multiple coil phases —three phases are shown in the example, although a four-phase embodiment may also be implemented. The coils are printed in longitudinal alignment along the PCB length, with each phase comprising a series of coil segments placed in close proximity to the embedded permanent magnet of the slider assembly. The three coil phases (Phase 1, Phase 2, and Phase 3) are driven sequentially in succession to produce a moving magnetic field. This phased actuation results in a corresponding movement of the magnetically responsive slider and scraper assembly along the electrodes. The driving circuit energizes each phase in turn, creating a traveling electromagnetic field that pushes or pulls the permanent magnet, and thereby moves the assembly rightward or leftward along the electrode axis.

FIG. 9E illustrates one example timing diagram for driving the three-phase electromagnetic coils of FIG. 9D. Each coil phase is energized for approximately 25 milliseconds before the next phase is activated. The phases are fired sequentially in the order Phase 1→Phase 2 →Phase 3, with no delay between transitions, resulting in a complete cycle time of approximately 75 milliseconds. After Phase 3 is energized, the firing sequence repeats continuously. This uninterrupted advancement of coil activation creates a smooth, continuous translation of the slider and scraper assembly along the electrodes. Reversing the activation order allows movement in the opposite direction. Each complete translation of the assembly along the emitter wire and collector plates performs a cleaning action that removes accumulated debris and thereby prolongs operational performance.

In some embodiments, the driving signals applied to the coil phases can be modified to control both the direction and the speed of movement of the magnetically responsive slider and scraper assembly. By changing the sequence of coil phase energization—such as reversing the order from Phase 1, Phase 2, Phase 3 to Phase 3, Phase 2, Phase 1—the traveling electromagnetic field is generated in the opposite direction along the PCB length, causing the permanent magnet within the slider assembly to move in the opposite longitudinal direction along the electrode axis. The speed of movement can be adjusted by altering the timing interval or frequency at which the coil phases are energized, allowing electronic control over cleaning translation rate. This capability enables bi-directional and variable-speed motion without requiring mechanical re-orientation or manual adjustment of the cleaning apparatus.

It should be understood that the configurations and operational sequences illustrated in FIG. 9C-9E are presented as examples only. The particular arrangement of the slider, scraper, permanent magnet, coil phases, and timing sequence represents one possible implementation of an electromagnetic motivator system, and numerous variations are possible. For instance, the number of coil phases, coil geometry, magnet type or placement, driving sequence, or coupling between scraper and slider may be altered to suit specific design requirements, manufacturing constraints, or performance objectives. Such modifications and alternative implementations fall within the scope of the concepts described herein.

### Adaptive Output Power Control

Embodiments of the present disclosure are further directed to an adaptive output power control for the EHD air mover device 200. The adaptive output power control may include a telemetry and control system for monitoring and dynamically adjusting the power supply for the EHD air mover device 200. The adaptive output power control may involve detection of the emitter electrode fouling and operational inefficiencies in relation to the EHD air mover device 200. Adaptive power adjustments may be applied to maintain a preferred performance of the EHD air mover device 200 while minimizing or at least reducing arcing. The adaptive output power control may further involve gradual power ramp-up for enhanced system longevity and stability.

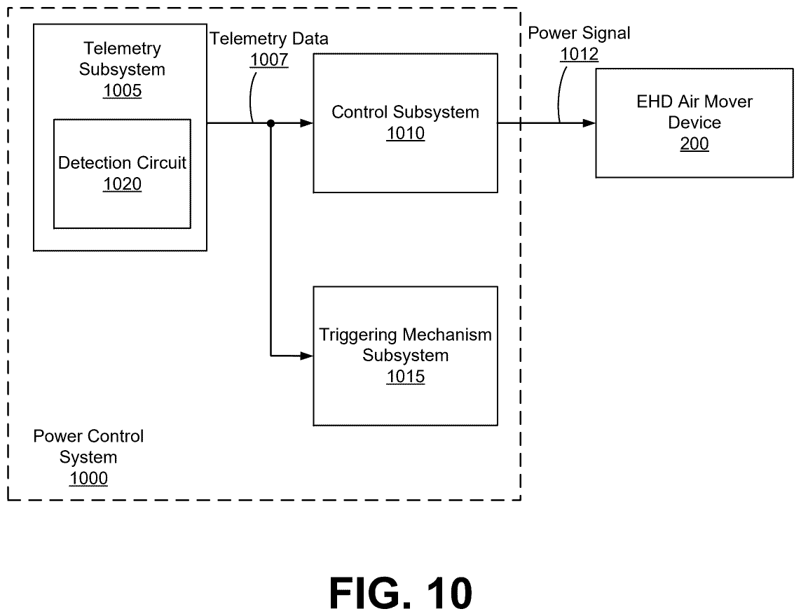

FIG. 10 illustrates a block diagram of a power control system 1000 for adaptive output power control at the EHD air mover device 200, in accordance with one or more embodiments. The power control system 1000 may include a telemetry subsystem 1005, a control subsystem 1010, and a triggering mechanism subsystem 1015. The power control system 1000 may include one or more additional components not shown in FIG. 10. Alternatively, one or more subsystems of the power control system 1000 may be bypassed or may be combined within a single subsystem.

The telemetry subsystem 1005 may include integrated sensors for measuring key electrical properties of the EHD air mover device 200 and providing real-time feedback on performance of the EHD air mover device 200. The telemetry subsystem 1005 may detect emitter electrode fouling and operational inefficiencies of the EHD air mover device 200 by monitoring electrical parameters of the EHD air mover device 200. Over time, the emitter electrode 210 may accumulate fouling, such as dust or silicon dioxide dendrites, which can reduce efficiency of the EHD air mover device 200 and lead to arcing. The telemetry subsystem 1005 may continuously monitor electrical properties of the EHD air mover device 200, such as voltage, current, and ion current across the emitter electrode 210 and/or the collector electrode 205. Changes in electrical characteristics (e.g., increased resistance or reduced ion current) may be used as indicators of fouling, such as dendrite growth or particle accumulation on the emitter electrode 210 and/or the collector electrode 205.

In one or more embodiments, the telemetry subsystem 1005 continuously monitors one or more electrical parameters of the EHD air mover device 200, such as a high-voltage output (ACout) from the emitter electrode 210, current flow and efficiency metrics calculated by comparing input power (DCin) applied to the EHD air mover device 200 with output power of the EHD air mover device 200, sudden current spikes indicative of arcing, gradual declines in operational efficiency correlated with fouling, some other electrical parameters, or some combination thereof. Data collected by the telemetry subsystem 1005 may allow the power control system 1000 to infer the operational state of the emitter electrode 210 and overall performance health of the EHD air mover device 200, enabling early detection of performance degradation. In one or more other embodiments, the telemetry subsystem 1005 can communicate with a host device into which the EHD air mover device 200 is integrated to report the performance level of the EHD air mover device 200.

The control subsystem 1010 may include a controller (e.g., control algorithm of software-based controller) that analyzes telemetry data 1007 obtained by the telemetry subsystem 1005 and adjusts the power supply output to maintain desired operating conditions of the EHD air mover device 200. In one or more embodiments, the control subsystem 1010 performs the adaptive power adjustments via dynamic power control. The control subsystem 1010 may dynamically adjust a power signal 1012 that controls the power supply of the EHD air mover device 200 to compensate for inefficiencies caused by fouling or other operational changes. This may ensure consistent airflow and pressure (P and Q) output at the EHD air mover device 200. The dynamic power control performed by the control subsystem 1010 may also prevent arcing at the EHD air mover device 200. Based on voltage and current patterns monitored by the telemetry subsystem 1005, the control subsystem 1010 may generate the power signal 1012 that preemptively reduces power or modifies electrical parameters of the EHD air mover device 200 to avoid conditions that could lead to arcing.

The control subsystem 1010 may further perform gradual power ramp-up for achieving the start-up optimization of the EHD air mover device 200. The control subsystem 1010 may generate the power signal 1012 that increases the power supply of the EHD air mover device 200 gradually during the start-up of the EHD air mover device 200, allowing the EHD air mover device 200 to stabilize before a full operating voltage is reached. This may reduce mechanical and electrical stress on components of the EHD air mover device 200, leading to extending the lifespan of the EHD air mover device 200. By performing the gradual power ramp-up, the control subsystem 1010 may achieve operational stability of the EHD air mover device 200. For example, by performing the gradual power ramp-up, sudden power fluctuations at the EHD air mover device 200 may be avoided, ensuring smoother operation and better reliability of the EHD air mover device 200.

An objective of the adaptive power adjustments performed by the control subsystem 1010 may be to maintain optimal performance of the EHD air mover device 200 and airflow while avoiding electrical breakdowns, e.g., arcing. In one or more embodiments, the control subsystem 1010 performs a dynamic voltage adjustment by modifying the voltage and current delivered to the emitter electrode 210 based on real-time efficiency measurements, e.g., obtained by the telemetry subsystem 1005. The dynamic voltage adjustment may compensate for performance drops caused by fouling. In one or more other embodiments, the control subsystem 1010 mitigates arcing at the EHD air mover device 200. For example, if the arcing is detected based on data collected by the telemetry subsystem 1005, the control subsystem 1010 may generate the power signal 1012 that temporarily reduces power or shuts down a supply of power to the emitter electrode 210 to allow the breakdown to subside, preventing damage of the EHD air mover device 200. By optimizing the power delivery, the control subsystem 1010 may reduce stress on electrical components of the EHD air mover device 200, thus extending operational life of the emitter electrode 210 and of the EHD air mover device 200. By adapting the power supply operation to a current state of the EHD air mover device 200, the control subsystem 1010 may minimize or at least reduce energy waste and ensure consistent performance of the EHD air mover device 200, i.e., the control subsystem 1010 may facilitate energy efficiency of the EHD air mover device 200.

An objective of the gradual power ramp-up performed by the control subsystem 1010 may be to enhance system stability, reduce electromagnetic interference (EMI), and minimize or at least reduce stress on components of the EHD air mover device 200 during the start-up. When the air mover device 200 is turned on, the control subsystem 1010 may generate the power signal 1012 that gradually increases the power sent to the emitter electrode 210 using pulse width modulation (PWM) or some other technique(s). This controlled power ramp-up may prevent sudden high-voltage surges that could lead to arcing or destabilizing of the corona discharge in a vicinity of the emitter electrode 210. The gradual power ramp-up may also reduce the risk of EMI, which can interfere with nearby electronic components of an electronic device into which the EHD air mover device 200 is integrated. In one or more embodiments, the control subsystem 1010 receives operational commands from the electronic device, e.g., for adjusting airflow and/or entering a power-saving mode at the EHD air mover device 200.

The triggering mechanism subsystem 1015 may initiate cleaning or general maintenance of the EHD air mover device 200. When fouling reaches critical levels (e.g., as detected by the telemetry subsystem 1005 based on the telemetry data 1007), the triggering mechanism subsystem 1015 may generate a triggering signal 1017 that initiates a cleaning mechanism at the EHD air mover device 200, e.g., a movement of an emitter cleaning bead/scraper and/or cleaning sliders. Alternatively, the triggering signal 1017 may be used to notify operators for manual intervention at the EHD air mover device 200. Based on efficiency metrics or arc counts available based on the telemetry data 1007 collected by the telemetry subsystem 1005, the triggering mechanism subsystem 1015 may generate the triggering signal 1017 for activating cleaning mechanisms at the EHD air mover device 200 (e.g., the movement of the emitter cleaning bead and/or the cleaning sliders) when fouling reaches a critical threshold.

In one or more embodiments, the telemetry subsystem 1005 includes a detection circuit 1020 that monitors one or more parameters of the EHD air mover device 200, such as high-voltage output (ACout), the efficiency ratio between input power (DCin) and output power, one or more other parameters, or some combination thereof. Data indicating gradual declines in efficiency of the EHD air mover device 200 and an increased rate of arcs at the EHD air mover device 200 (e.g., as detected by the detection circuit 1020) may be used by the telemetry subsystem 1005 to determine a level of fouling of the emitter electrode 210, primarily caused by silicon dioxide dendrites. The telemetry subsystem 1005 may also detect dust accumulation on the collector electrode 205 and other indicators of reduced performance of the EHD air mover device 200.

Based on the one or more parameters detected by the telemetry subsystem 1005, the control subsystem 1010 may adjust the power sent to the emitter electrode 210, e.g., to compensate for performance drops due to fouling and/or avoid excessive power that could lead to arcing or electrical breakdowns at the EHD air mover device 200. When fouling reaches a critical level (e.g., as detected by the telemetry subsystem 1005), the triggering mechanism subsystem 1015 may trigger cleaning mechanisms, such as an emitter cleaning bead and/or collector cleaning sliders, to restore emitter electrode efficiency and/or collector electrode efficiency.

The power supply of the EHD air mover device 200 may include three main stages, i.e., a low-power stage, a high-power stage, and a telemetry and control stage. The low-power stage may convert low-voltage DC input (e.g., 5-24 V) into medium-voltage AC output using, e.g., a metal-oxide-semiconductor field-effect transistor (MOSFET) for PWM. The high-power stage may further amplify the medium-voltage AC signal to the high-voltage DC (e.g., 3000-5000 V) via, e.g., a diode-capacitor ladder. The telemetry and control stage may include the telemetry subsystem 1005 and the control subsystem 1010. The telemetry and control stage may monitor, communicate, and control the power supply operation using, e.g., firmware on a microcontroller. Upon receiving a power-on signal, the control subsystem 1010 may ramp up power gradually using PWM to, e.g., prevent arcing and instability during startup, reduce EMI, and minimize or at least reduce stress on electrical components of the EHD air mover device 200, enhancing the lifetime of the EHD air mover device 200.

The power control system 1000 may communicate with the electronic device into which the EHD air mover device 200 enabling commands to adjust “fan” levels based on cooling requirements of the electronic device. Thus, the power control system 1000 may thus facilitate feedback in relation to the system performance and operational state of the EHD air mover device 200. The power control system 1000 may further provide (e.g., via the control subsystem 1010) adjustments to PWM levels for precise control of power output.

The power control system 1000 may further provide for real-time response to operational changes at the EHD air mover device 200. The power control system 1000 may detect (e.g., via the telemetry subsystem 1005) rapid changes in high-voltage signals, such as spikes caused by arcing, and respond (e.g., via the control subsystem 1010) by temporarily shutting off or reducing power supply to stabilize the operation of the EHD air mover device 200. Continuous monitoring of operational parameters of the EHD air mover device 200 (e.g., via the telemetry subsystem 1005 and the detection circuit 1020) may allow for dynamic power adjustments to optimize efficiency and maintain a preferred level of performance of the EHD air mover device 200.

To maintain the preferred level of performance of the EHD air mover device 200, the power control system 1000 may ensure consistent airflow and pressure output by adapting to changing conditions such as fouling or variable input voltages. The power control system 1000 may also facilitate reduction of downtime of the EHD air mover device 200 and/or maintenance needs caused by performance degradation. To prevent arcing, the power control system 1000 may proactively adjust (e.g., via the control subsystem 1010) power supply parameters to prevent destructive arcing events, which can damage components of the EHD air mover device 200 and reduce reliability of the EHD air mover device 200.

By applying the gradual power ramp-up and intelligent power management, the power control system 1000 may reduce wear and tear on the emitter electrode 210 and other components of the EHD air mover device 200, thus enhancing durability of the EHD air mover device 200. By compensating for fouling and arcing, the power control system 1000 may prolong the operational life of the EHD air mover device 200. The power control system 1000 may also optimize power usage, ensuring energy-efficient operation of the EHD air mover device 200, as well as reduction in unnecessary power consumption at the EHD air mover device 200, thus ensuring operational efficiency of the EHD air mover device 200.

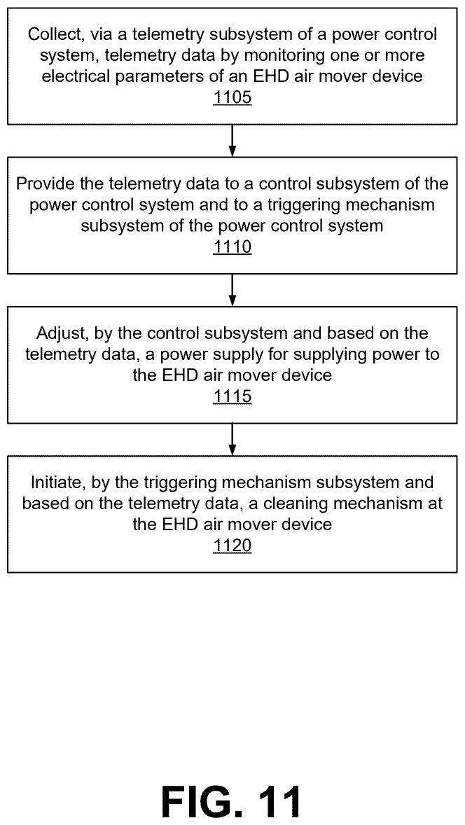

FIG. 11 is a flowchart for a method of adaptive output power control for the EHD air mover device 200, in accordance with one or more embodiments. Alternative embodiments may include more, fewer, or different steps from those illustrated in FIG. 11, and the steps may be performed in a different order from that illustrated in FIG. 11. These steps may be performed automatically by a power control system, such as the power control system 1000.

The power control system collects 1105, via a telemetry subsystem of the power control system (e.g., the telemetry subsystem 1005), telemetry data by monitoring one or more electrical parameters of an EHD air mover device, e.g., the EHD air mover device 200.

The power control system provides 1110 the telemetry data to a control subsystem of the power control system (e.g., the control subsystem 1010) and to a triggering mechanism subsystem of the power control system (e.g., the triggering mechanism subsystem 1015).

The power control system adjusts 1115, by the control subsystem and based on the telemetry data, a power supply (e.g., the power supply 120) for supplying power to the EHD air mover device.

The power control system initiates 1120, by the triggering mechanism subsystem and based on the telemetry data, a cleaning mechanism at the EHD air mover device. The power control system may initiate the cleaning mechanism by initiating a movement of an emitter cleaning bead (e.g., the emitter wire cleaner 305) and/or a movement of cleaning sliders (e.g., the cleaning sliders 810a, 810b, the cleaning slider apparatus 830, or the cleaning slider apparatus 910).

### Adaptive Multi-Stage Power Input and Control

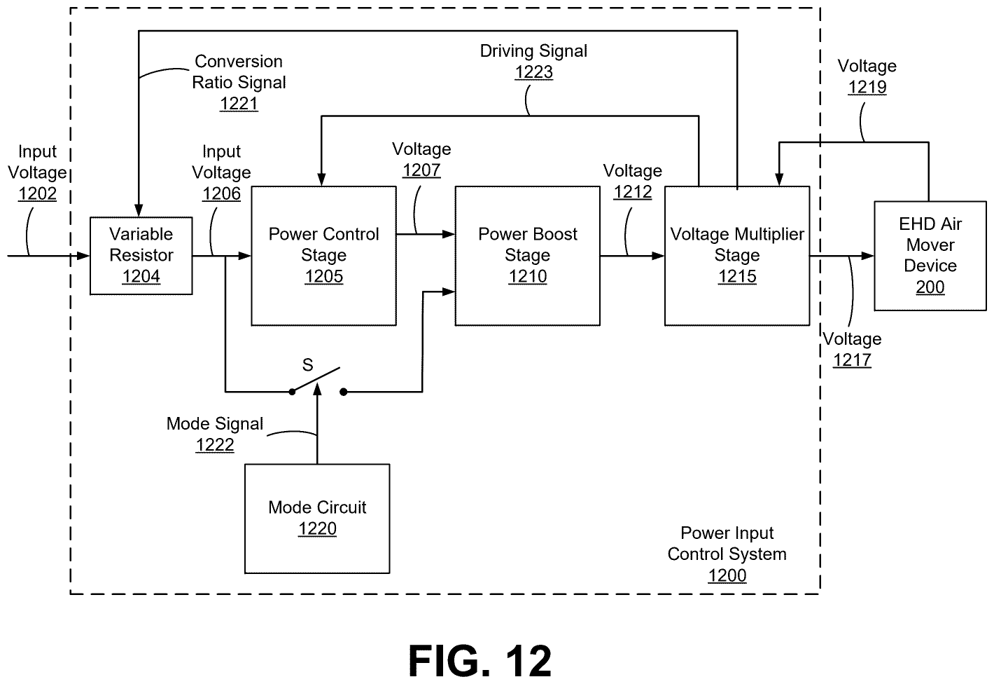

Embodiments of the present disclosure are further directed to an adaptive multi-stage power input and control for the EHD air mover device 200. FIG. 12 illustrates a block diagram of a power input control system 1200, in accordance with one or more embodiments. The power input control system 1200 may include a variable resistor 1204, a power control stage 1205, a power boost stage 1210, a voltage multiplier stage 1215, and a mode circuit 1220. The variable resistor 1204 may control a level of voltage input into the power boost stage 1210. The power control stage 1205 may include a buck converter or some other circuit for regulating an input voltage variability. The power boost stage 1210 may include a fixed-gain boost converter or some other circuit for intermediate power conversion. The voltage multiplier stage 1215 may include a voltage multiplier circuit for delivering a high voltage to the EHD air mover device 200 (e.g., to the emitter electrode 210). The mode circuit 1220 may control a switch S (e.g., MOSFET transistor) and configure the power input control system 1200 to operate either in a two-stage mode or a three-stage mode. The power input control system 1200 may include one or more additional components not shown in FIG. 12. Alternatively, one or more stages of the power input control system 1200 may be bypassed or may be combined within a single stage.

In one or more embodiments, the mode circuit 1220 generates a signal 1222 that closes the switch S (e.g., turns on the MOSFET transistor) and configures the power input control system 1200 to operate in the two-stage mode, i.e., as a two-stage high voltage power supply system. In such cases, the power control stage 1205 is bypassed, and an input voltage 1206 provided via the variable resistor 1204 representing a ratio of an input voltage 1202 may be directly provided to the power boost stage 1210. The power input control system 1200 may utilize a variable DC power source to generate the input voltage 1202. For example, the variable DC power source may be a chargeable battery that has an unknown voltage level with a range of, e.g., 10V to 20V, 20V to 40V, or 9V to 50V. The power boost stage 1210 may be a PWM-controlled boost stage producing a voltage 1212 that is an AC voltage of, e.g., 400-650V p-p (peak-to-peak). The voltage multiplier stage 1215 may convert the voltage 1212 (e.g., 600V AC voltage) into a voltage 1217 that is a DC voltage of, e.g., 5000V. The voltage 1217 may be applied to one or more components of the EHD air mover device 200, such as the emitter electrode 210. The voltage 1217 may represent a high voltage DC output of the power input control system 1200.

As shown in FIG. 12, an output load of the power input control system 1200 is the EHD air mover device 200, which has a variable resistance load based on environmental conditions. During the operation of the EHD air mover device 200, the voltage multiplier stage 1215 may produce the voltage 1217, i.e., a high voltage DC output that is input to the EHD air mover device 200, whereas a feedback line from the EHD air mover device 200 is also connected to the voltage multiplier stage 1215 providing a DC voltage 1219 generated by the EHD air mover device 200. The voltage multiplier stage 1215 may compare the voltage 1217 to the voltage 1219 to determine the voltage level and power level being delivered to the EHD air mover device 200. Once this power level is determined, a conversion ratio can be determined to set the input voltage 1206 by setting the variable resistor 1204, which in turn sets the voltage 1212 as a precision input voltage for the voltage multiplier stage 1215. Information about the conversion ratio may be carried by a conversion ratio signal 1221 that is fed back from the voltage multiplier stage 1215 to the variable resistor 1204. In such cases, the voltage multiplier stage 1215 may generate the voltage 1217 (i.e., output high voltage) such that a level of the voltage 1217 delivers the desired output voltage and power to the EHD air mover device 200.

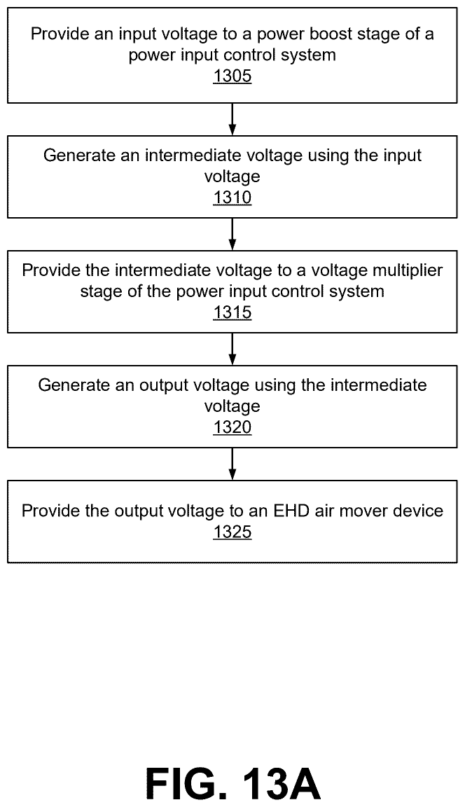

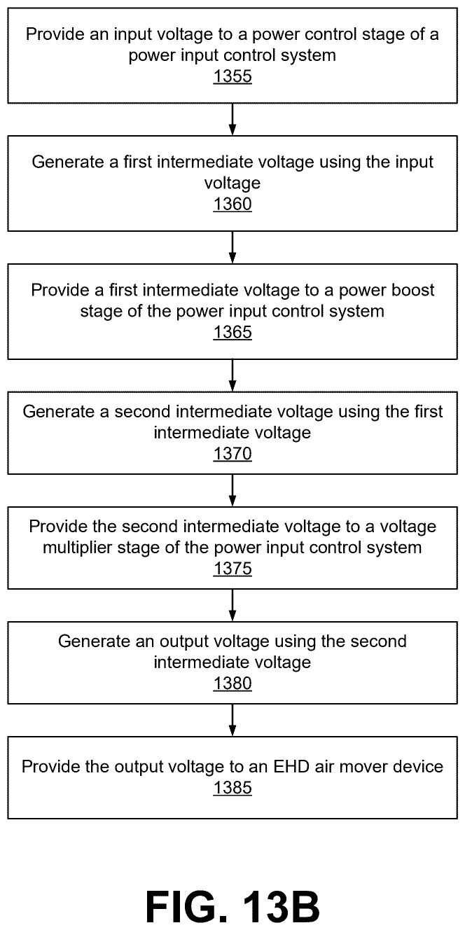

FIG. 13A is a flowchart for a method of a two-stage power input and control for the EHD air mover device 200, in accordance with one or more embodiments. Alternative embodiments may include more, fewer, or different steps from those illustrated in FIG. 13A, and the steps may be performed in a different order from that illustrated in FIG. 13A. These steps may be performed automatically by a power input control system, such as the power input control system 1200.

The power input control system provides 1305 an input voltage (e.g., the input voltage 1206) to a power boost stage (e.g., the power boost stage 1210) of the power input control system. The input voltage may be a DC voltage of, e.g., 5V.

The power input control system generates 1310 (e.g., via the power boost stage 1210) an intermediate voltage using the input voltage. The intermediate voltage may be an AC voltage of, e.g., 400-650V peak-to-peak.

The power input control system provides 1315 the intermediate voltage to a voltage multiplier stage of the power input control system, e.g., the voltage multiplier stage 1215.

The power input control system generates 1320 (e.g., via the voltage multiplier stage 1215) an output voltage using the intermediate voltage. The output voltage may be a DC voltage of, e.g., 5000V.

The power input control system provides 1325 the output voltage to an EHD air mover device, e.g., the EHD air mover device 200 and the emitter electrode 210.

Referring back to FIG. 12, in one or more embodiments, the mode circuit 1220 generates the signal 1222 that opens the switch S (e.g., turns off the MOSFET transistor) and configures the power input control system 1200 to operate in the three-stage mode, i.e., as a three-stage high voltage power supply system. In such cases, the variable resistor 1204 may be also shorted, and the input voltage 1206 provided to the power control stage 1205 may correspond to the input voltage 1202. The power control stage 1205 may thus receive the input voltage 1206 (e.g., DC battery voltage) that is a variable DC voltage (e.g., with a range of 10V to 20V) based on the discharge level of the system battery. The power control stage 1205 may convert the input voltage 1206 to a DC voltage 1207 and a power level needed to drive the EHD air mover device 200 with a required power level. The power boost stage 1210 may be a fixed frequency boost stage that converts the DC voltage 1207 into an AC output voltage 1212 of, e.g., 400-650V peak-to-peak. The voltage multiplier stage 1215 may include a multiplier circuit that converts the AC voltage 1212 (e.g., 600V AC) into the output high voltage 1217 (e.g., approximately 5000V DC).

The output load of the power input control system 1200 is the EHD air mover device 200, which has a variable resistance load based on environmental conditions. Power to the output load may be monitored via the voltage 1219 fed back to the voltage multiplier stage 1215. Based on a comparison between the voltage 1217 and the voltage 1219, the voltage multiplier stage 1215 may generate a driving signal 1223 that is fed back to the power control stage 1205, e.g., to the buck converter of the power control stage 1205. The driving signal 1223 may drive the buck converter of the power control stage 1205 to generate the voltage 1207 having a desired voltage level.

FIG. 13B is a flowchart for a method of a three-stage power input and control for the EHD air mover device 200, in accordance with one or more embodiments. Alternative embodiments may include more, fewer, or different steps from those illustrated in FIG. 13B, and the steps may be performed in a different order from that illustrated in FIG. 13B. These steps may be performed automatically by a power input control system, such as the power input control system 1200.

The power input control system provides 1355 an input voltage (e.g., the input voltage 1202) to a power control stage (e.g., the power control stage 1205) of the power input control system. The input voltage may be a battery input DC voltage having a range between 10V and 20V.

The power input control system generates 1360 (e.g., via the power control stage 1205) a first intermediate voltage using the input voltage. The first intermediate voltage may be a DC voltage of a predefined level.

The power input control system provides 1365 the first intermediate voltage to a power boost stage of the power input control system, e.g., the power boost stage 1210.

The power input control system generates 1370 (e.g., via the power boost stage 1210) a second intermediate voltage using the first intermediate voltage. The second intermediate voltage may be an AC voltage of, e.g., 400-650V peak-to-peak.

The power input control system provides 1375 the second intermediate voltage to a voltage multiplier stage of the power input control system, e.g., the voltage multiplier stage 1215.

The power input control system generates 1380 (e.g., via the voltage multiplier stage 1215) an output voltage using the second intermediate voltage. The output voltage may be a DC voltage of, e.g., 5000V.

The power input control system provides 1385 the output voltage to an EHD air mover device, e.g., the EHD air mover device 200 and the emitter electrode 210.

### Cleaning Actuators

In some embodiments, the electrode cleaning apparatus include cleaning actuators configured to remove fouling and contaminants from both emitter and collector electrodes in the presence of high electric fields. The cleaning actuator integrates electrode-cleaning components with an actuation system that operates under high-voltage conditions while minimizing electrical breakdown, arcing, and electrical creep. In some embodiments, the cleaning actuator includes an emitter cleaner, a collector cleaner, and an actuation system adapted for high-field operation. The actuator may be implemented in different embodiments including mechanical, electromagnetic, pneumatic, and acoustic implementations. The actuator is configured to provide effective contaminant removal while maintaining dielectric integrity, suppressing arcing, and reducing creep phenomena.

In some embodiments, for emitter electrode cleaning, an emitter electrode cleaner is configured to shear dendrites, fibrous contaminants, and other debris from the emitter electrode. The emitter cleaner applies mechanical force directly to the electrode surface or to contaminants bridging the inter-electrode gap. The emitter cleaner may be fabricated from abrasive or wear-resistant materials such as alumina, ceramic composites, or other high-dielectric materials. These materials are selected for resistance to mechanical wear and stability under high-voltage electric fields. In some embodiments, the material is configured to resist electrical breakdown at operating voltage. In some embodiments, the geometry of the emitter cleaner is configured to minimize or at least reduce electrical arcing and reduce surface electrical creep, thereby preserving long-term reliability and the charged particle emission system.

For collector electrode cleaning, a collector electrode cleaner is provided to remove dust, fibrous contaminants, or other airborne particulates from collector electrode surfaces or the inter-electrode gap. The emitter cleaner may be fabricated from materials including (but not limited to) alumina, ceramic materials, and high-dielectric composites, chosen for durability and dielectric strength. In some embodiments, the material is configured to resist dielectric breakdown under system voltage. The geometry of the collector cleaner is configured to reduce arcing propensity and suppress electrical creep effects across the electrode surfaces.

In some embodiments, the emitter cleaner may be moved longitudinally relative to the emitter electrode. In some embodiments, longitudinal movement may be achieved through direct coupling to a mechanically actuated element. In some embodiments, movement may be induced via electromagnetic coils. The emitter cleaner in this case may be ferromagnetic and responds to applied magnetic field. In some embodiments, the emitter electrode may be translated through a fixed scraper by bi-directional spooling at device ends. To initiate cleaning of emitter and collector electrodes, the mode switch is set to cleaning mode, which engages the buck-converter stage to generate a low-voltage, high current power supply in order to drive the electromagnetic coils. The coil driver circuit is activated to create a magnetic field that induces movement to left and right in order to completely traverse the emitter and collector electrodes. A sensing element can confirm the position of the emitter and collector scraper slider assembly when complete.

In some embodiments, acoustic phased arrays are configured to direct focused acoustic waves onto the emitter electrode. The focal point of acoustic energy may be swept along the emitter length to form a translating cleaning wave, providing enhanced debris removal.

In some embodiments, vibrational and acoustic energy may be imparted by actuating a spring-loaded emitter terminal. Suitable actuation devices include (but are not limited to) piezoelectric transducers, electromagnetic solenoids, electromagnetic coils, voice coils, or vibrator assemblies.

In some embodiments, an integrated cleaning actuator may couple emitter and collector cleaning through a magnetically actuated slider. The slider may incorporate a magnet array arranged with alternating field orientations to produce high magnetic field gradients. The slider may be driven longitudinally by electromagnetic coils fabricated as traces on a printed circuit board (PCB). In some embodiments, multiphase signals may be applied to the coil traces generate controlled motion.

In some embodiments, interdigitated coil traces may be configured to support multiple phases. The PCB copper layers may be separated by prepreg dielectric material or covered by high-dielectric insulation to limit leakage current (e.g., below 10 μA) or suppress an induced voltage when high voltage is applied to the emitter electrode.

In some embodiments, for coupling between emitter and collector cleaners, a forked structure on the slider may mechanically engage the emitter bead during cleaning cycles, allowing coupled motion while maintaining separation during idle states. In some embodiments, open-circuit separation during idle is configured to reduce arcing risk between electrodes. In some embodiments, the emitter bead and collector slider remain structurally independent to isolate emitter electrode from transverse stresses.

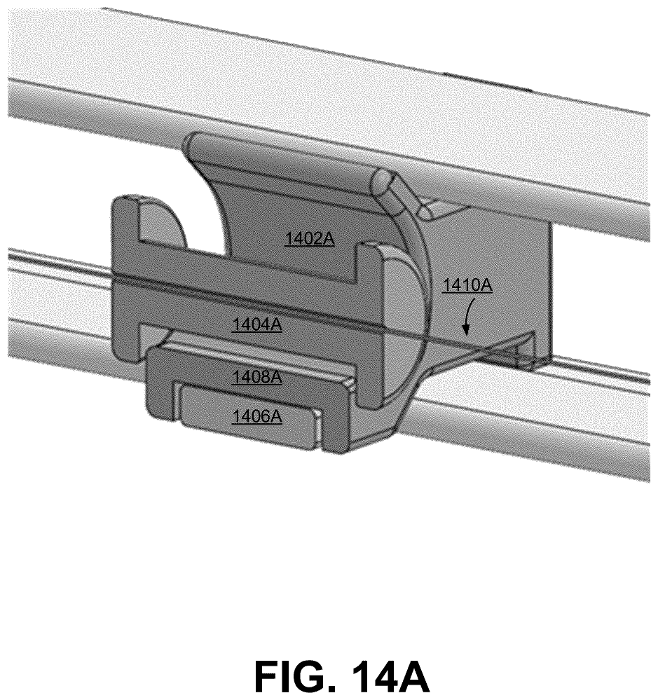

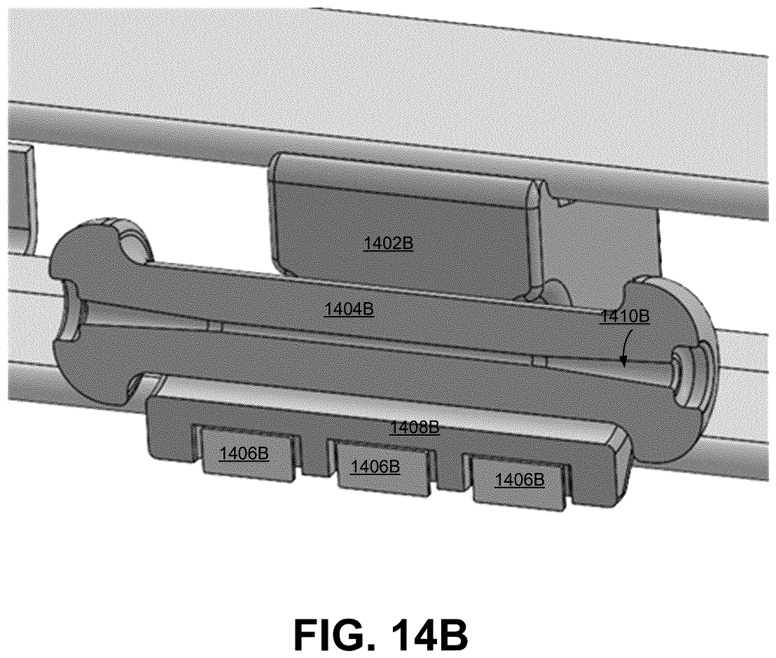

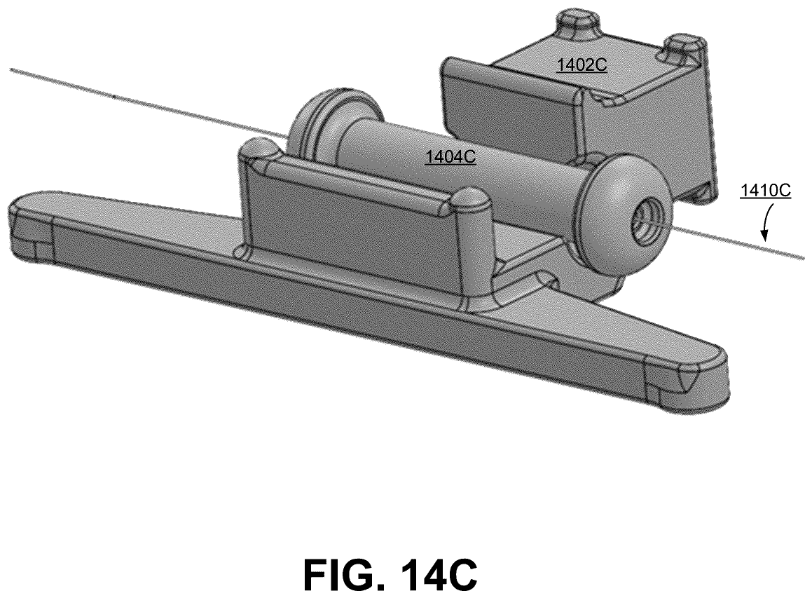

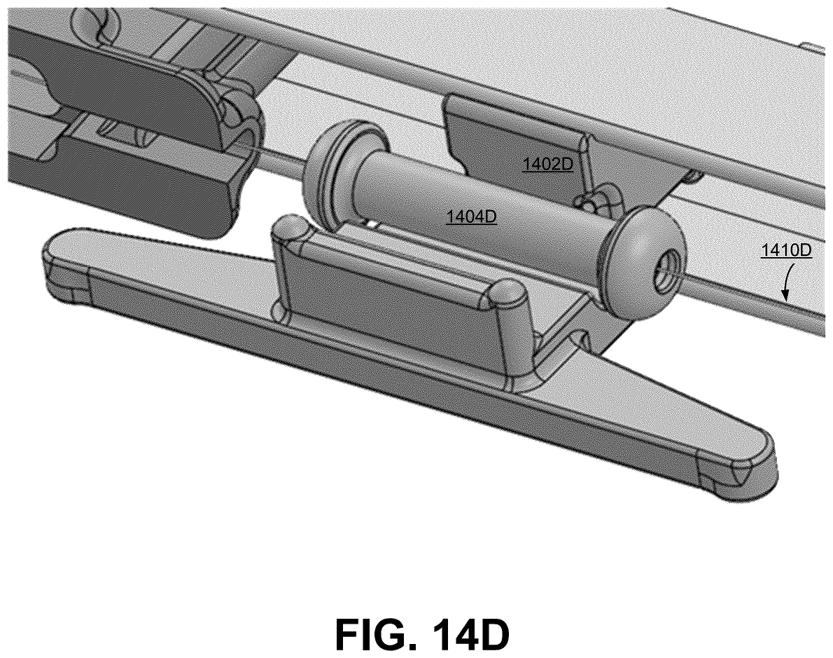

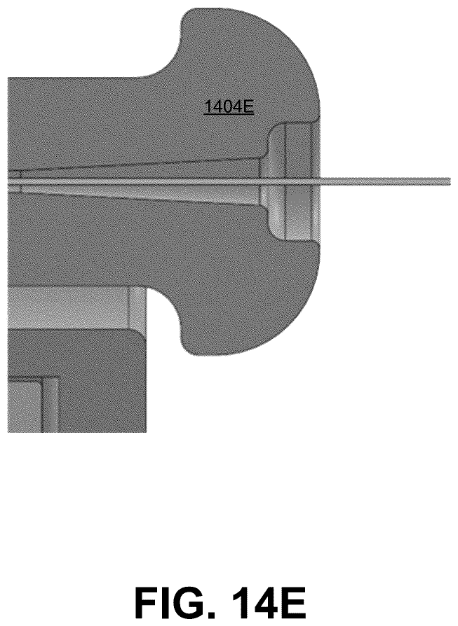

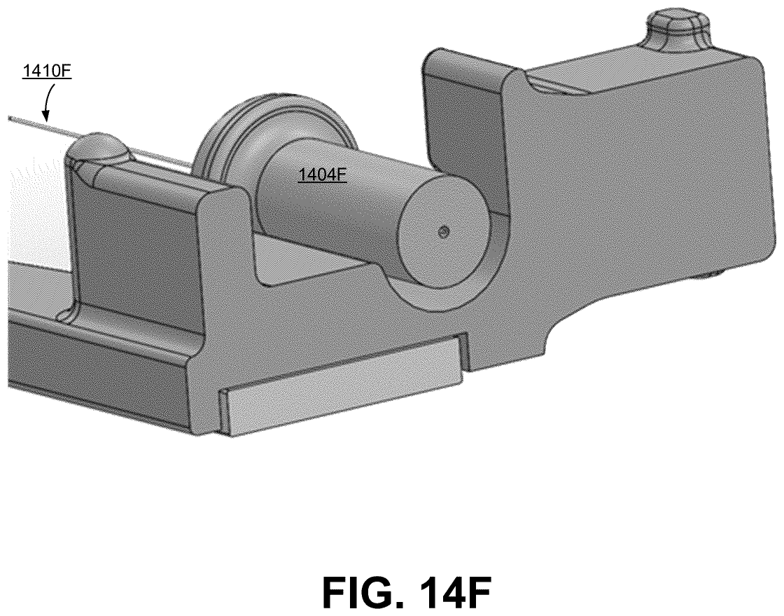

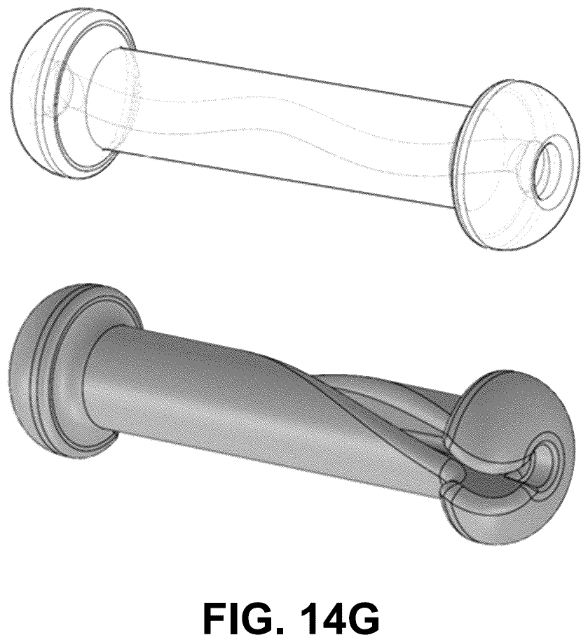

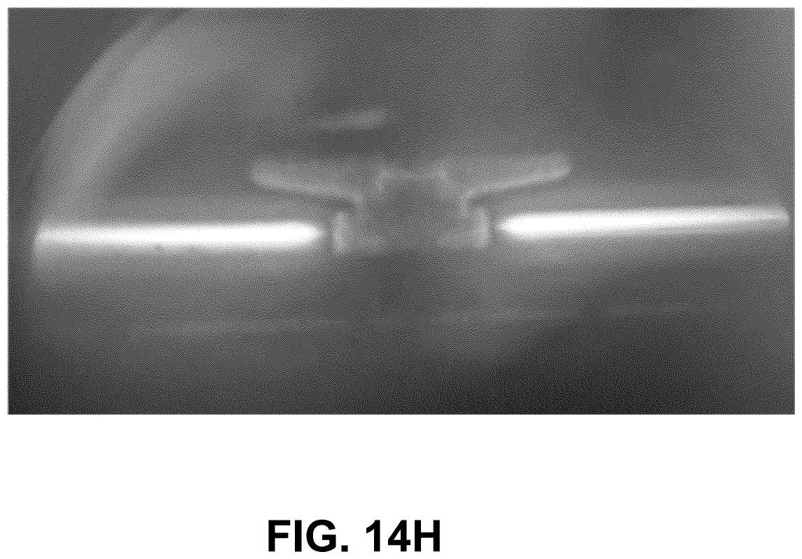

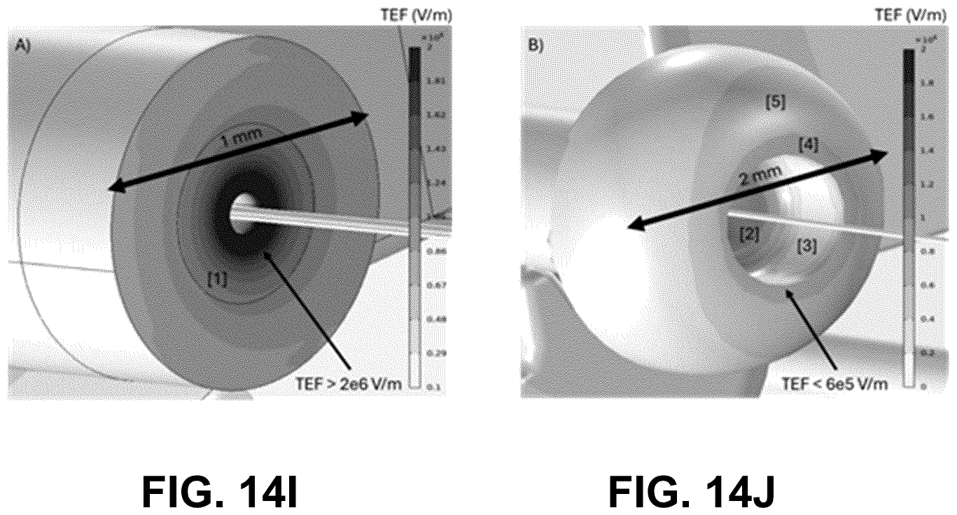

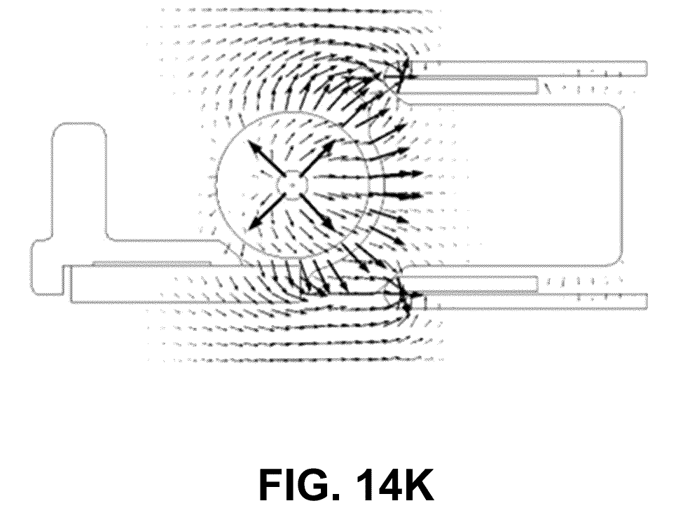

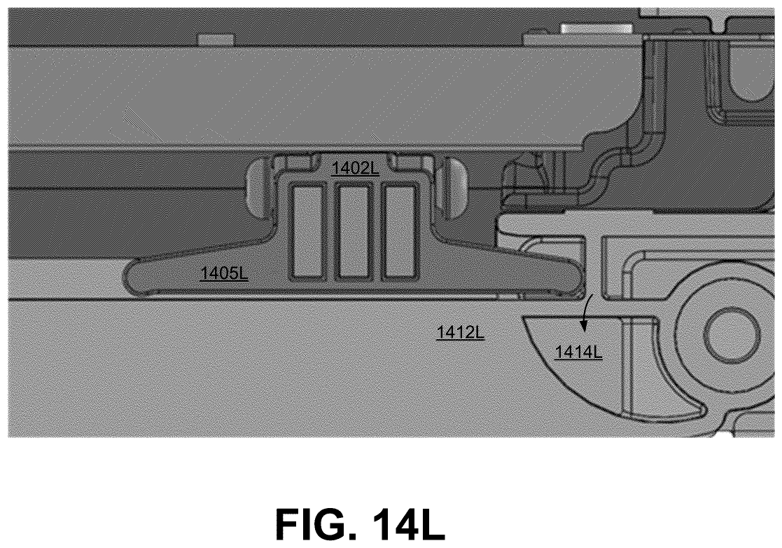

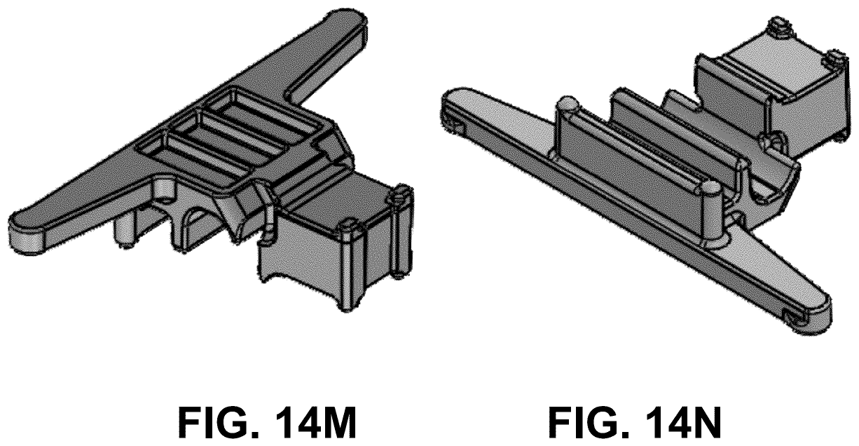

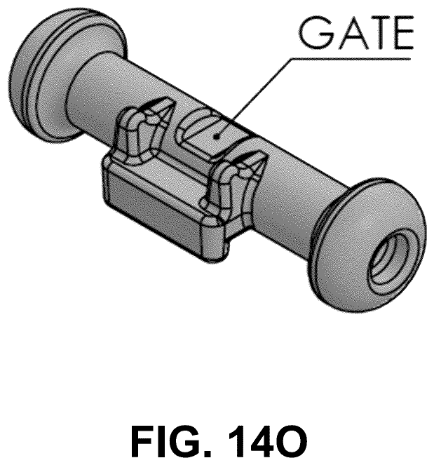

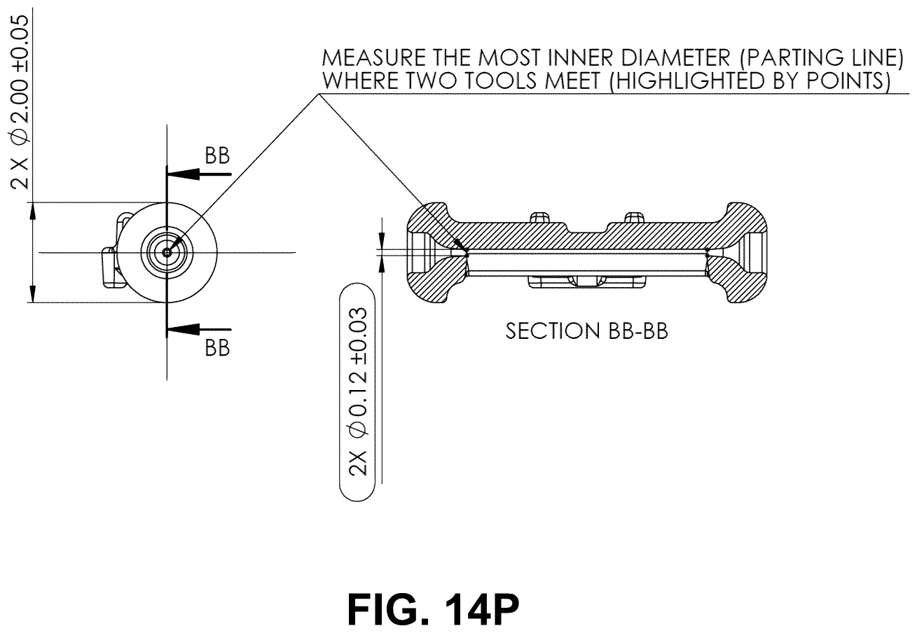

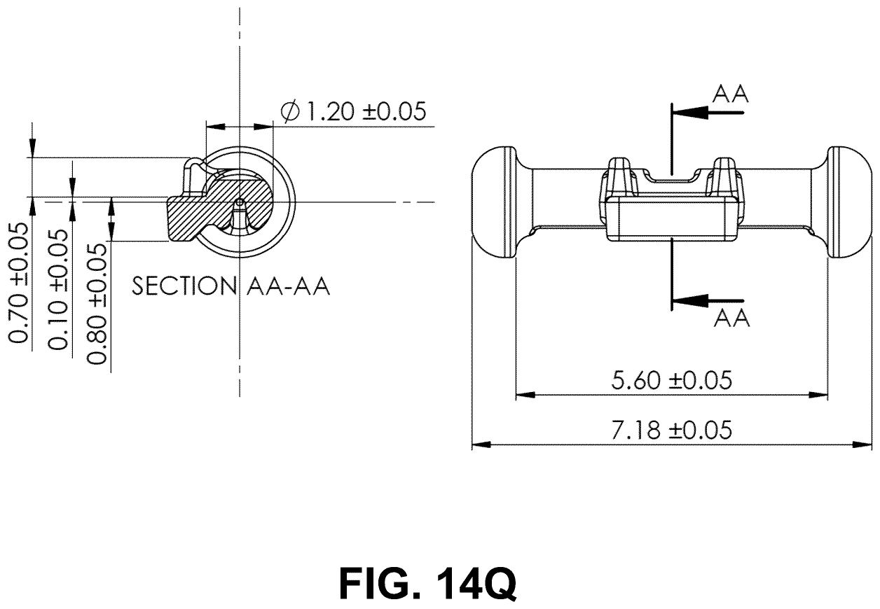

FIG. 14A illustrates an embodiment of a coupled emitter-collector cleaning actuator in which a fork-like collector slider 1402A mechanically overlaps an emitter bead cleaner 1404A. Note, only half of the bead is depicted for illustration purposes so as to reveal the underlying emitter electrode. The slider 1402A incorporates embedded magnets 1406A and is driven longitudinally by electromagnetic coils located on a printed circuit board 1408A. As the slider translates, the fork-like projection engages the emitter bead 1404A, causing it to move along the emitter electrode. In the idle state, the slider 1402A and bead 1404A remain separated to reduce arcing propensity and mechanical stress transfer to the emitter wire 1410A.

In some embodiments, a magnet array may be implemented. The array may include multiple magnets oriented in alternating north-up and north down configurations, thereby maximizing interaction with multiphase coil fields. In some embodiments, dimensions may include magnets of 1 mm width and 0.5 mm height, with length adjustable to vary force magnitude. Example configuration include up-down-up or down-up-down sequences, with the number of magnets, spacing between magnets, and specific orientation, and distance to underlying coil traces determining total driving force.

In some embodiments, the geometry of the electromagnetic coil traces relative to the magnet array is optimized to improve cleaning performance. The relative angle between the coil traces and the magnets affects the balance of longitudinal (x-direction) and transverse (y-and z-direction) forces applied to the slider. By adjusting this coil-to-magnet angle, the actuation mechanism can be tuned to maximize forward translation while minimizing undesirable lateral loading on the collector slider or emitter bead.

In some embodiments, the coil pitch is selected to match or complement the magnet pitch of the embedded magnet array. For example, when the magnet array is configured in a repeating N-S-N orientation, the copper trace coils may be patterned with a corresponding periodicity to maximize interaction efficiency. Proper alignment of coil pitch to magnet pitch enhances the net longitudinal driving force and suppresses off-axis motion.

In some embodiments, the coplanarity of the coil traces and the embedded magnets is controlled within tight tolerances to ensure consistent electromagnetic coupling. Variations in coplanarity can degrade efficiency and increase the likelihood of undesired vertical forces. Accordingly, the coil angle, coil pitch, and coil-magnet coplanarity are treated as critical-to-quality design parameters for the actuation system.

FIG. 14B illustrates an embodiment of an emitter electrode scraper and a collector slider including multiple magnets. Again, only half of the scraper is depicted for illustration purposes so as to reveal the underlying emitter wire. In this configuration, the collector slider includes a series of magnets 1406B aligned in alternating polarity to interact with multiphase coil traces on a PCB 1408B. The slider portion 1402B mechanically couples with the emitter scraper 1404B such that movement of the slider 1402B drives coordinated movement of the emitter scraper 1404B. The arrangement maintains structural independence between the slider 1402B and scraper 1404B, thereby isolating the emitter wire 1410B from non-longitudinal stresses while still enabling synchronized cleaning actuation.

FIG. 14C illustrates a perspective view of an emitter scraper 1404C mounted in a ceramic support structure. In this view, a whole bead 1404C is shown. The scraper 1404C is aligned with the emitter wire and positioned within a collector slider housing 1402C. This configuration demonstrates the bead includes recessed ends configured to minimize high tangential electric fields at its end surfaces, thereby suppressing arcing under high-voltage operation.

FIG. 14D illustrates the same bead and slider structure in the assembled state with the emitter wire in place. The collector slider is positioned such that the emitter bead overlaps with the slider, providing field shielding and mechanical coupling. This overlap ensures that bead motion occurs in tandem with slider motion, while maintaining electrical separation when idle.

FIG. 14E illustrates a cross-sectional view of bead 1404E showing the internal bore through which the emitter wire extends. As illustrated, at each end, the bead 1404D incorporates recessed ceramic holes and rounded ends that reduce tangential electric field concentration near the collector region. The section view reveals the tapered passage and seating profile of the bead, which are otherwise hidden in perspective views. This depiction clarifies the alignment of the emitter wire relative to the bead's internal geometry. These features suppress arc initiation in regions of close electrode proximity.

FIG. 14F illustrates a cross-sectional view of bead 1404F in relation to emitter wire 1410F. The section shows the bead positioned around the emitter wire, with the wire extending through the central bore of the bead to provide support and alignment.

FIG. 14G illustrates an example bead incorporating a twisting helical inner hole. The helix maximizes wire contact during a cleaning cycle by rotating the engagement surface around the wire circumference. The helix can extend within the bead body or extend outside the bead radius as a slit. Because the helix confines the electric field, no preferential corona or breakdown path to the collector slider is formed.

FIG. 14H shows an experimental image of the bead-wire region under energized conditions. The absence of corona discharge confirms that the open-helix bead geometry can be implemented without preferential arcing, while also enabling simplified assembly by twisting the bead onto the emitter wire.

FIGS. 14I and 14J illustrate simulated tangential electric field (TEF) distributions around different bead terminus geometries. In FIG. 14I, the planar bead terminus [1] adjacent to the emitter wire [6] exhibits TEF exceeding 2×10\hat{ }6 V/m, leading to observed arcing at 4.8 kV. In FIG. 14J, a 0.4 mm radius×0.326 mm depth cutout is introduced at the bead terminus, removing the material responsible for arcing. The inner surface [2] remains at high field due to proximity to the wire [6], but no arcing occurs since the TEF is perpendicular to the cup wall [3]. Outer wall [4] exhibits reduced TEF due to increased separation. Both inner [2] and outer [4] surfaces are curved to reduce the integral of the tangential field component, thereby reducing arc propensity.

FIG. 14K illustrates a cross-section view showing electric field vectors emanating from the emitter wire. The field is suppressed inside the bead and slider due to the high dielectric constant of those structures, further reducing arc likelihood in narrow gap.

FIG. 14L illustrates an example collector slider chassis 1412L in accordance with one or more embodiments. The slider 1402L includes slider feet 1405L, which limit the approach distance to the isolator region (on the right), while chassis 1412L include a stop 1414L that prevents excessive travel of the collector slider 1402L. Such a mechanical stop 1414L protects against arcing by maintaining minimum separation distances between high-voltage structures.

FIGS. 14M-14N illustrate perspective views of a collector slider chassis in accordance with one or more embodiments. The chassis is shown from an angle that reveals the slider coupling arms and central support region in which embedded magnets or other actuation features can be mounted. The chassis includes mounting features for attaching the collector contacting elements and mechanical interfaces for engaging with an emitter cleaning bead or scraper during coupled movement cycles.

FIG. 14O illustrates an example embodiment of emitter cleaning bead in accordance with one or more embodiments. The bead includes end flanges for dielectric spacing and a central coupling feature for engagement with the collector slider chassis. The view depicts a “gate” location used in molding or manufacturing the bead, positioned away from high-field operational zones to preserve dielectric integrity and surface finish.

FIG. 14P illustrates a cross-sectional view of the emitter cleaning bead taken along line BB-BB, together with an end-profile. The section view reveals the internal bore of the bead through which the emitter wire passes and highlights the location of the parting line where two molding tools meet.

FIG. 14Q illustrates an assembled view showing the mechanical coupling configured to engage the collector slider chassis. The coupling feature allows the bead to be driven longitudinally along the emitter wire via coordinated motion of the collector slider chassis under electromagnetic or mechanical actuation, while maintaining electrical isolation between the emitter and collector components.

### Additional Considerations

Embodiments of the present disclosure are directed to an electrode cleaning apparatus for an EHD air mover device, e.g., the EHD air mover device 200. The electrode cleaning apparatus may include a cleaning scraper made of one or more non-conductive materials, e.g., the emitter electrode cleaner 305, the emitter electrode cleaner 405, the emitter electrode cleaner 420, the emitter electrode cleaner 505, the emitter electrode cleaner 605, or the emitter electrode cleaner 705. The cleaning scraper may be placed on an emitter electrode of the EHD air mover device, e.g., the emitter electrode 210. The cleaning scraper may have a hole (e.g., the hole 310) through which a wire of the emitter electrode passes so that the cleaning bead is free to slide longitudinally along the wire of the emitter electrode. The electrode cleaning apparatus may further include a cleaning slider made of at least one non-conductive material, e.g., the cleaning sliders 810a, 810b, the cleaning slider apparatus 830, or the cleaning slider apparatus 910. The cleaning slider may be placed around a pair of plates (e.g., the plates 205a, 205b) of a collector electrode of the EHD air mover device (e.g., the collector electrode 205) so that the cleaning slider is free to slide longitudinally along the pair of plates of the collector electrode.

The cleaning scraper may move along a length of the emitter electrode when an electronic device into which the EHD air mover device is integrated moves, vibrates, rotates, or accelerates. Similarly, the cleaning slider may slide longitudinally along the pair of plates of the collector electrode when the electronic device into which the EHD air mover device is integrated moves, vibrates, rotates, or accelerates.

An outer surface of the cleaning bead may include a slit (e.g., the slit 610) for placing the wire of the emitter electrode through the slit and twisting the cleaning bead onto the wire of the emitter electrode. The cleaning bead may further include one or more magnetic materials that react to an external magnetic structure (e.g., the series of electromagnets 710) creating a magnetic field that causes a movement of the cleaning bead along a length of the wire of the emitter electrode. The external magnetic structure may include traces of wire on a printed circuit board (PCB) of a housing of the EHD air mover device.

The cleaning slider may include a first cleaning slider (e.g., the cleaning slider 810a, the cleaning slider 830a, or the cleaning slider 910a) placed around a first plate of the pair of plates (e.g., the plate 805a) and a second cleaning slider (e.g., the cleaning slider 810b, the cleaning slider 830b, or the cleaning slider 910b) placed around a second plate of the pair of plates (e.g., the plate 805b). The cleaning slider may further include a connector (e.g., the member 840) that connects the first cleaning slider with the second cleaning slider so that the first cleaning slider and the second cleaning slider move simultaneously along lengths of the first plate and the second plate. The cleaning slider may further include one or more first bearings (e.g., the bearings 815a, the bearings 835a, or the bearing 920a) on the first cleaning slider and one or more second bearings (e.g., the bearings 815b, the bearings 835b, or the bearing 920b) on the second cleaning slider.

The cleaning apparatus may further include a second connector that connects the cleaning scraper to the cleaning slider so that the cleaning bead moves along a length of the emitter electrode simultaneously with movements of the first cleaning slider and the second cleaning slider along the lengths of the first plate and the second plate of the collector electrode.

At least one of a movement of the cleaning scraper longitudinally along the emitter electrode or a movement of the cleaning slider longitudinally along the pair of plates of the collector electrode may be initiated by a triggering mechanism (e.g., the triggering mechanism subsystem 1015) based on sensor data collected via one or more sensors placed on the EHD air mover device, the sensor data including information about one or more electrical parameters of the EHD air mover device.

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or. ” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. An electrode cleaning apparatus, comprising:
a cleaning scraper made of one or more non-conductive materials, the cleaning scraper placed on an elongate emitter electrode of an electro-hydrodynamic (EHD) air mover device, the cleaning scraper having an opening configured to receive the elongate emitter electrode so that the cleaning scraper is slidable longitudinally along the emitter electrode,
wherein the elongate emitter electrode is a conductive edge on a mounting isolator, and the cleaning scraper is configured to engage and scrape deposits from the conductive edge.

2. The electrode cleaning apparatus of claim 1, wherein the cleaning scraper includes a capture feature configured to engage a guide on the mounting isolator, the guide maintaining alignment of the cleaning scraper with the emitter electrode during movement.

3. The electrode cleaning apparatus of claim 1, wherein the cleaning scraper moves along a length of the elongate emitter electrode when an electronic device into which the EHD air mover device is integrated moves, vibrates, rotates, or accelerates.

4. The electrode cleaning apparatus of claim 1, wherein the cleaning scraper includes a magnetic element,
wherein the electrode cleaning apparatus further includes an electromagnetic motivator configured to generate a varying magnetic field that interacts with the magnetic element in the cleaning scraper to move the cleaning scraper longitudinally along the emitter electrode.

5. The electrode cleaning apparatus of claim 4, wherein the electromagnetic motivator includes a plurality of electromagnetic coils arranged along a printed circuit board (PCB) in overlapping longitudinal alignment adjacent a path of travel of the cleaning scraper.

6. The electrode cleaning apparatus of claim 5, wherein the plurality of electromagnetic coils are arranged in three or more phases and are driven sequentially to generate the varying electromagnetic field along a length of the PCB.

7. The electrode cleaning apparatus of claim 6, wherein reversal of a sequential driving order of the three or more phases produces translation of the cleaning scraper in an opposite longitudinal direction along the emitter electrode.

8. The electrode cleaning apparatus of claim 1, further comprising a cleaning slider made of at least one non-conductive material, the cleaning slider placed around a pair of plates of a collector electrode of the EHD air mover device so that the cleaning slider is free to slide longitudinally along the pair of plates of the collector electrode, wherein the cleaning slider comprises a first cleaning slider placed around a first plate of the pair of plates and a second cleaning slider placed around a second plate of the pair of plates.

9. The electrode cleaning apparatus of claim 8, wherein the cleaning slider further includes a connector that connects the first cleaning slider with the second cleaning slider so that the first cleaning slider and the second cleaning slider move simultaneously along lengths of the first plate and the second plate.

10. The electrode cleaning apparatus of claim 9, further comprising a second connector that connects the cleaning scraper to the cleaning slider so that the cleaning scraper moves along a length of the emitter electrode simultaneously with movements of the first cleaning slider and the second cleaning slider along the lengths of the first plate and the second plate.

11. The electrode cleaning apparatus of claim 10, wherein the cleaning slider further includes one or more first bearings on the first cleaning slider and one or more second bearings on the second cleaning slider.

12. The electrode cleaning apparatus of claim 11, wherein at least one of a movement of the cleaning scraper longitudinally along the emitter electrode or a movement of the cleaning slider longitudinally along the pair of plates of the collector electrode is initiated by a triggering mechanism based on sensor data collected via one or more sensors placed on the EHD air mover device, the sensor data including information about one or more electrical parameters of the EHD air mover device.

13. A cleaning actuator for a charged particle emission system, comprising:
an emitter electrode cleaner configured to physically contact and scrape deposits from an elongate emitter electrode, the emitter electrode cleaner including:
a bead that has a central bore through which the emitter electrode extends; and
a semi-helical slit extending from an outer surface of the bead toward a central bore to allow mounting of the bead onto the elongate emitter electrode without threading over a length of the elongate emitter electrode; and
an actuation system including an electronic circuit operable to move the bead relative to the emitter electrode.

14. The cleaning actuator of claim 13, wherein the bead includes:
a body portion; and
end portions on opposite ends of the body portion, each end portion having an outwardly projecting flange configured to maintain a dielectric spacing from adjacent components, wherein transitions between the flanges and the body portion are rounded to reduce localized electric field concentration during operation.

15. The cleaning actuator of claim 14, wherein the body portion of the bead further includes:
a coupling portion configured to engage a stop portion on an isolator element to limit rotational movement of the bead.

16. The cleaning actuator of claim 15, wherein the coupling portion and the stop portion cause a semi-helical slit in the bead oriented away from a collector electrode during operation, thereby reducing likelihood of arcing between the bead and the collector electrode.

17. The cleaning actuator of claim 13, wherein the actuation system further comprises an acoustic phased array configured to direct focused acoustic energy along the emitter electrode, a focal point being translated to form a sweeping cleaning wave.

18. The cleaning actuator of claim 14, wherein vibrational energy is imparted to the emitter electrode cleaner by actuating a spring-loaded emitter terminal with a piezoelectric transducer, electromagnetic solenoid, voice coil, or vibrator assembly.

19. The cleaning actuator of claim 14, further comprising a collector electrode cleaning slider configured to contact and clean a pair of collector electrode plates, wherein the collector electrode cleaning slider is mechanically coupled to the bead such that movement of the slider along the collector electrode plates causes coordinated movement of the bead along the elongate emitter electrode.

20. The cleaning actuator of claim 19, wherein the actuation system is an electromagnetic actuation system configured to generate a varying magnetic field, and
wherein the slider includes a magnetic element disposed therein such that the varying magnetic field generated by the actuation system interacts with the magnetic element to move the slider longitudinally along the pair of collector electrode plates.
